(19) United States
(12) Patent Application Publication
(10) Pub. No.: US 2010/0176138 A1
(43) Pub. Date: Jul. 15, 2010

(54) SYSTEM AND METHOD FOR MOUNTING ELECTRICAL DEVICES

(75) Inventors: Steven Zacharevitz, Northport, NY (US); George Wei, Flushing, NY (US); Marc Noest, Westbury, NY (US); Dennis Oddsen, Eatons Neck, NY (US); Gary Bateson, Pawcatuck, CT (US)

Correspondence Address: Collard & Roe, P.C./Leviton, 1077 Northern Blvd, Roslyn, NY, 11576, US

(73) Assignee: LEVITON MANUFACTURING COMPANY INC., Melville, NY (US)

(21) Appl. No.: 12/602,639

(22) PCT Filed: Jun. 19, 2009
(86) PCT No.: PCT/US09/48063

§ 371 Date: Mar. 15, 2010

(30) Foreign Application Priority Data
Jul. 18, 2008 (US) PCT/US2008/070546

(51) Int. Cl. B65D 25/00; B23P 11/00

(52) U.S. Cl. 220/737; 29/428

(57) ABSTRACT

There is a commercial wiring system and method for wiring, which is designed to increase the speed of installation of wiring devices. In one embodiment of the invention there is a bracket which is designed to receive an adapted wiring box. This bracket has tabs for fixing to a wiring box to form an electrical box. The bracket can be coupled to another bracket that is adjustable in length and includes at least two legs, with a first leg being slidable in position in relation to a second track. A first set of tracks in the first assembly is designed to receive the second set of tracks in the second assembly in a telescoping or nested manner. The adjustable electrical box assembly can include a box section, a mounting plate and a mud ring or plaster ring.

### CROSS REFERENCE TO RELATED APPLICATIONS

This application is a non provisional application and hereby claims priority from provisional application Ser. No. 60/951,091 filed on Jul. 20, 2007, and from provisional application Ser. No. 60/976,786 filed on Oct. 1, 2007, wherein the disclosure of these two applications are hereby incorporated herein by reference in their entirety.

### BACKGROUND

### 1. Field

The invention relates to a system and method for mounting electrical devices. The system can include an adjustable and reconfigurable bracket system. The method includes using an adjustable and reconfigurable bracket system which is used to mount electrical boxes. In the past, during construction, electrical boxes would be mounted based upon attaching an electrical box to a framing member on a wall. The level or positioning of this attachment may be based upon the specifications set forth by the architect, the contractor, local codes and/or the building owner. Electrical boxes are normally mounted in walls, ceilings and/or floors to support electrical devices such as outlets, light switches and/or other similar types of devices.

Brackets for mounting wall boxes are shown in U.S. Pat. No. 7,053,300 to Denier which issued on May 30, 2006 which discloses a multi-purpose bracket for supporting electrical boxes in a stud wall.

Embodiments of the present invention provide a mounting bracket system and method that provides improved adjustability and reconfigurability.

### SUMMARY

One embodiment of the invention relates to a bracket for coupling to a wiring box. The bracket comprises at least one body section comprising a plurality of body fastener holes and at least four sides. On at least one side is a first flange having a flange fastener hole. This first flange extends from at least a portion of the first side. This first flange is configured and arranged on the first side to interdigitate with a complementary flange from another bracket when the other bracket is mounted adjacent to the first side. This bracket is configured to attach to a wiring box on a back surface and to a mud ring on an opposite surface. This bracket can then be coupled to an adjustable mounting system as well.

The above described mounting bracket can be coupled to an associated wiring box and can also be coupled to at least one adjustable bracket which is adjustable in length. The adjustable bracket includes nestable tracks which are slidable within each other and can be formed from any suitable shape such as a “C” shape. The track can be set at a particular length using a fastener. In addition, a fastener can also be used for fastening the mounting bracket to the adjustable bracket. Fasteners can also be used to couple at least one end plate to the adjustable bracket. Any suitable fastener can be used such as an integral track locking tab, a screw such as a sheet metal screw, a bolt, a rivet, a nail, a clamp, a peg, a pin, an anchor, a clasp or any other suitable fastener known in the art.

The invention can also include a method for assembling and installing the mounting bracket and the adjustable bracket. This method can include coupling the mounting bracket directly to the wiring box, and then optionally connecting a mud ring to at least one of the mounting bracket or the wiring box to form an assembled electrical box. This assembled electrical box can then be coupled to an adjustable bracket. Either before or after this coupling, this adjustable bracket can be adjusted in length. The adjustable bracket can also be coupled to a framing member as well, either before the assembled electrical box is coupled to the adjustable bracket or after the assembled electrical box is coupled to the adjustable bracket.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1A is an exploded perspective view of a wiring box, a mounting bracket and a mud ring;

FIG. 1B is a perspective view of the assembled components of FIG. 1A;

FIG. 1C is a back view of the view shown in FIG. 1A;

FIG. 1D is a back view of the view shown in FIG. 1B;

FIG. 1E shows a back view of the bracket shown in FIG. 1A;

FIG. 2A is a perspective view of an assembled electrical wiring box coupled to an adjustable bracket;

FIG. 2B is a front view of two assembled electrical boxes positioned adjacent to each other on an adjustable bracket;

FIG. 2C is a front view of three assembled electrical wiring boxes positioned adjacent to each other on an adjustable bracket;

FIG. 2D is a front view of two assembled electrical wiring boxes positioned adjacent to each other on an adjustable bracket;

FIG. 2E is a front view of two assembled electrical wiring boxes positioned adjacent to each other along an axis different from the axis shown in FIGS. 2B, 2C, and 2D;

FIG. 3A is an exploded perspective view of an upper assembly for the adjustable bracket;

FIG. 3B is an exploded perspective view of a lower assembly for the adjustable bracket;

FIG. 4A is a perspective view of the adjustable bracket showing the upper assembly inserting into the lower assembly;

FIG. 4B is a perspective view of the adjustable bracket with the upper assembly inserted into the lower assembly;

FIG. 5 is an exploded view of another embodiment of an electrical wiring box, mounting bracket and mud ring assembly;

FIG. 6 is an unexploded view of FIG. 5;

FIG. 7 shows the assembly of FIG. 6 as it is positioned to be coupled to the adjustable bracket;

FIG. 8A is a perspective view of a first configuration of the mounting system coupled to vertical framing members;

FIG. 8B is a perspective view of a second configuration of the mounting system coupled to vertical framing members;

FIG. 8C is a perspective view of another embodiment including a single set of tracks;

FIG. 8D is a perspective view of another configuration of the mounting system coupled to vertical framing members;

FIG. 9 is a perspective view of the mounting system coupled in a vertical manner to a framing member;

FIG. 10A is a perspective view of the electrical box coupled to a vertical framing member;

FIG. 10B is a perspective view of the wiring box and bracket and a wire guide directly coupled to a vertical framing member;

FIG. 11 is a perspective view of a another embodiment of an adjustable bracket;

FIG. 12A is a front perspective view of the embodiment of FIG. 11 illustrating nested track members;

FIG. 12B is a back perspective view of the embodiment of FIG. 12A;

FIG. 13 is a perspective view of one embodiment of a mounting bracket coupled to two sets of electrical wiring boxes and mud rings;

FIG. 14 is a perspective view of the assembly of FIG. 13 coupled to an embodiment of the adjustable bracket extending in a vertical manner;

FIG. 15 is a perspective view of an electrical wiring box and mounting bracket assembly coupled to the embodiment shown in FIGS. 12A and 12B of the adjustable bracket extending in a horizontal manner between two framing members;

FIG. 16 is illustrates the assembly shown in FIG. 15 with a reduced spacing between the two framing members;

FIG. 17 is a perspective view of an electrical wiring box and mounting bracket assembly coupled to a framing member in a vertical manner;

FIG. 18 is a perspective view of the assembly shown in FIG. 13 coupled to a vertical framing member in a horizontal manner;

FIG. 19 is a perspective view of another embodiment of a mounting system;

FIG. 20 is a perspective view of the embodiment shown in FIG. 19 with two electrical boxes installed;

FIG. 21 is a perspective view of an electrical wiring box and mounting bracket assembly coupled to a framing member;

FIG. 22 A is a flow chart for an example of a method for installation using an embodiment;

FIG. 22 B is a flow chart for an example of a method for installation using a another embodiment;

FIG. 23 is a flow chart for assembling an electrical wiring box and mounting bracket assembly including the components of FIG. 1A;

FIG. 24 is a flow chart for one process for mounting the embodiment shown in FIGS. 19-21;

FIG. 25 is a flow chart for another process for configuring and mounting the adjustable bracket;

FIG. 26 shows an additional embodiment which shows an adjustable far side support from a first perspective view;

FIG. 27 shows a second view of the embodiment shown in FIG. 26;

FIG. 28A is a perspective view of a first embodiment of a bracket shown in FIGS. 26 and 27;

FIG. 28B is a perspective view of a second embodiment of a bracket shown in FIGS. 26 and 27;

FIG. 29 shows a flow chart for the series of steps for using the embodiment shown in FIGS. 26, 27 and 28A and 28B;

FIG. 30 is a front perspective view of a first orientation of a cable guide;

FIG. 31 is a back perspective view of the cable guide shown in FIG. 30;

FIG. 32 is a front perspective view of a second orientation of the cable guide shown in FIG. 30; and

FIG. 33 is a back perspective view of the cable guide shown in FIG. 32.

### DETAILED DESCRIPTION OF THE PREFERRED EMBODIMENT

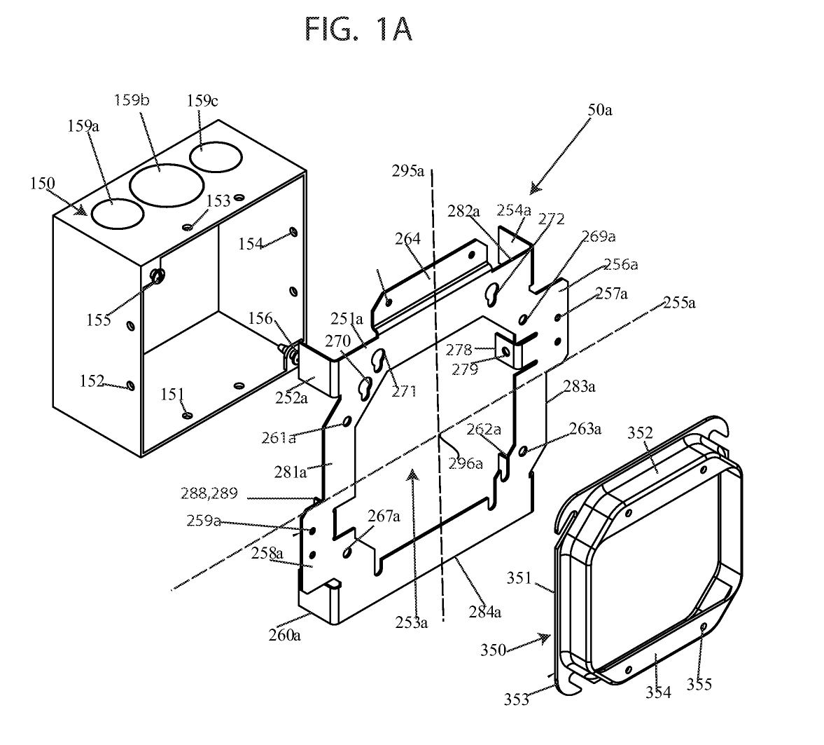

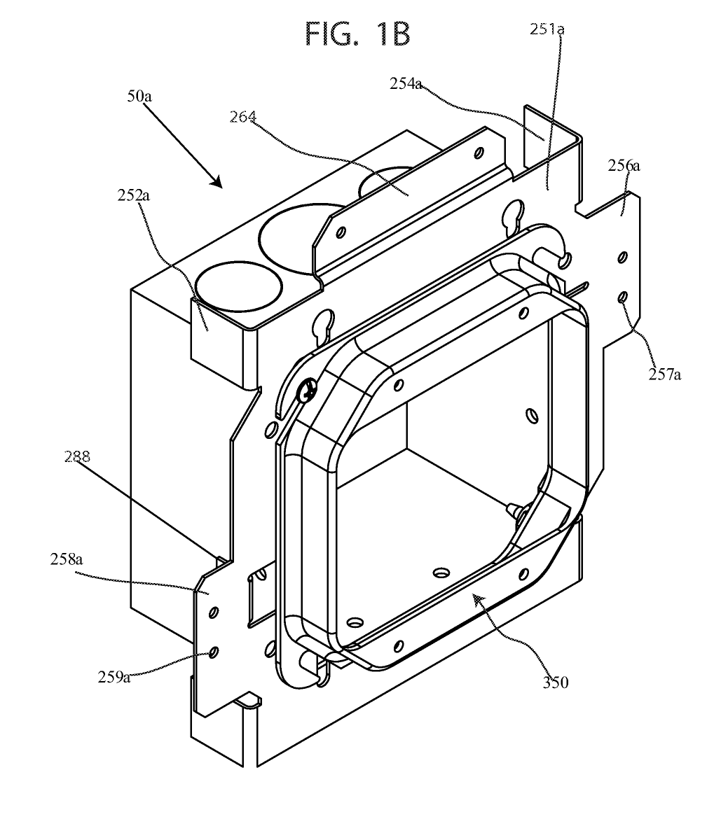

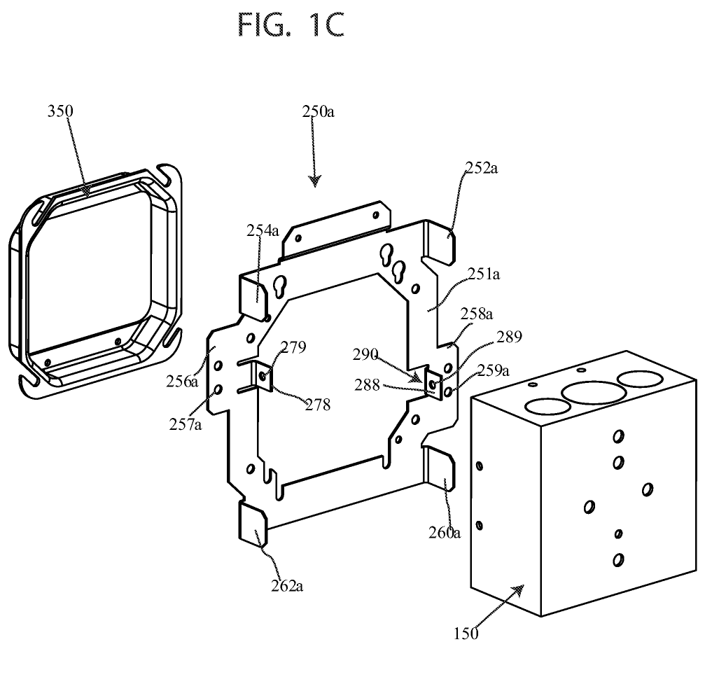

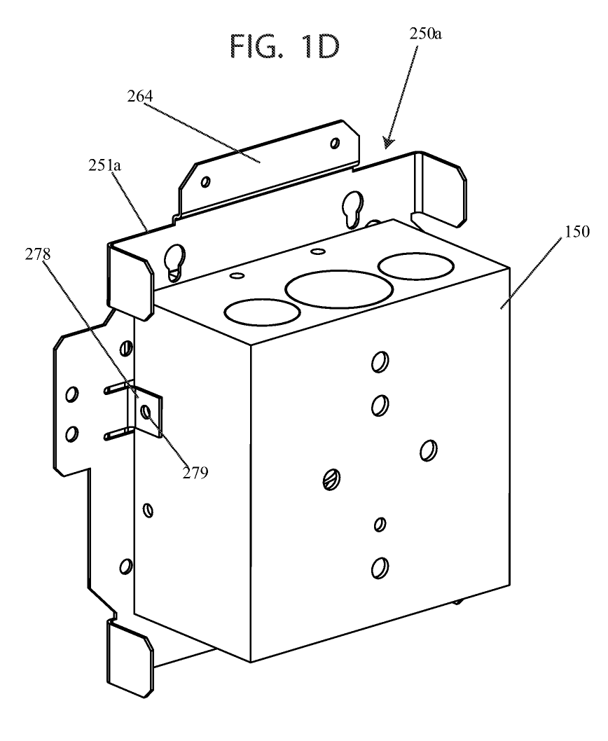

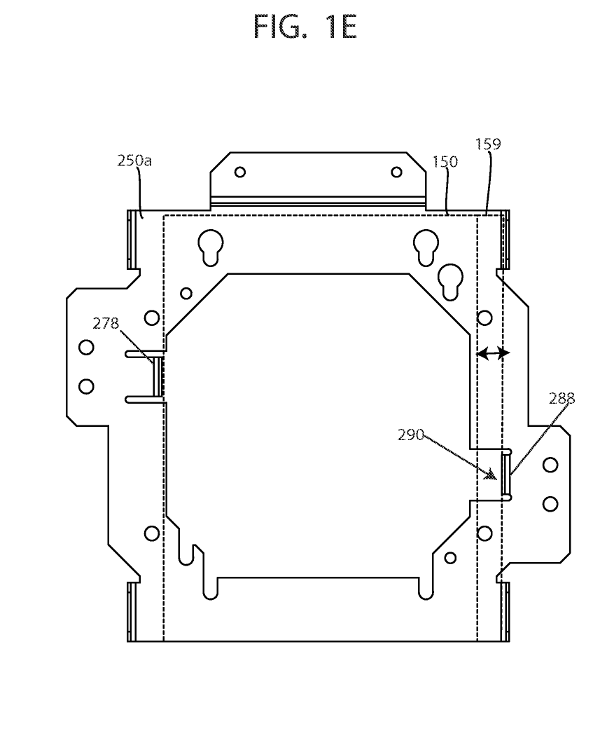

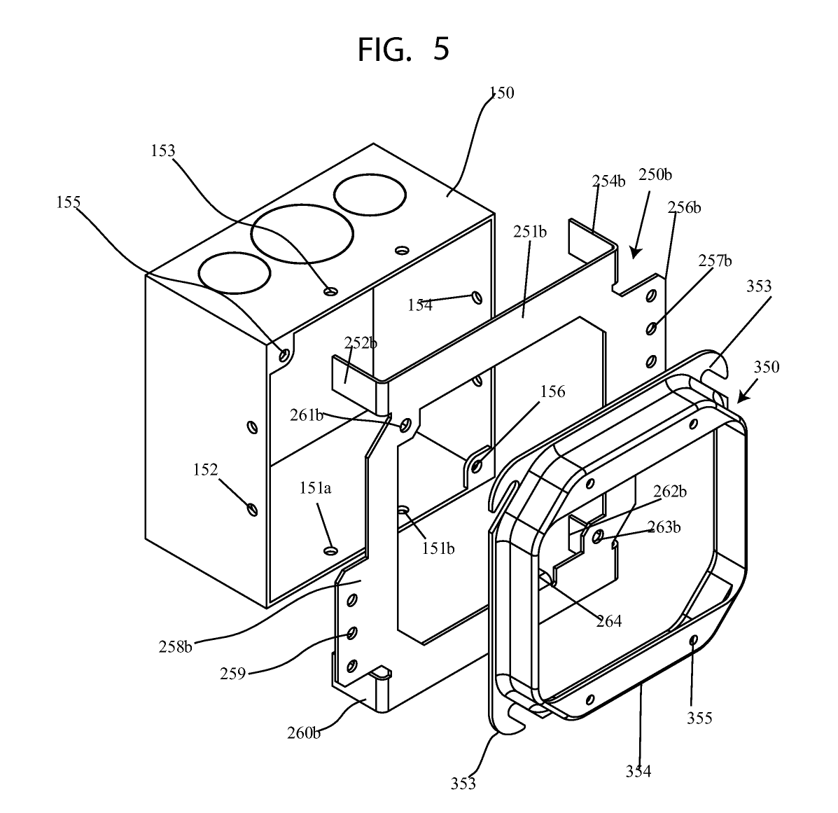

FIG. 1A shows an exploded perspective view of a wiring box and mounting bracket configuration in the form of an electrical box configuration 50a. Wiring box 150 comprises a five sided box, with a back side, four lateral sides and an open face. The four lateral sides have fastener holes 151, 152, 153, and 154. There are also holes 159a, 159b and 159c which are for receiving cables. Wiring box 150 can have corner connections or fasteners 155 and 156 for connecting to a mounting bracket 250a, and/or to a mud ring 350 Fasteners 155 and 156 are shown as sheet metal screws. Wiring box 150 can be in the form of a single gang electrical enclosure but in this embodiment, is shown as a double gang electrical enclosure. This wiring box 150 can be made from any material that is suitable, such as plastic, metal, or the like. A mounting plate or mounting bracket 250a is shown, wherein wiring box 150 is configured to receive multiple different types of mounting brackets or plates such as mounting bracket 250a shown in FIG. 1A or mounting bracket 250b shown in FIG. 5. Mounting bracket 250a includes a body section 251a having four sides. The four sides are a first side 281a, a second side 282a, a third side 283a, and a fourth side 284a. The body section 251a of mounting bracket 250a includes a substantially planar surface forming a front face for coupling to a mud ring 350 and a rear face for coupling to a wiring box 150.

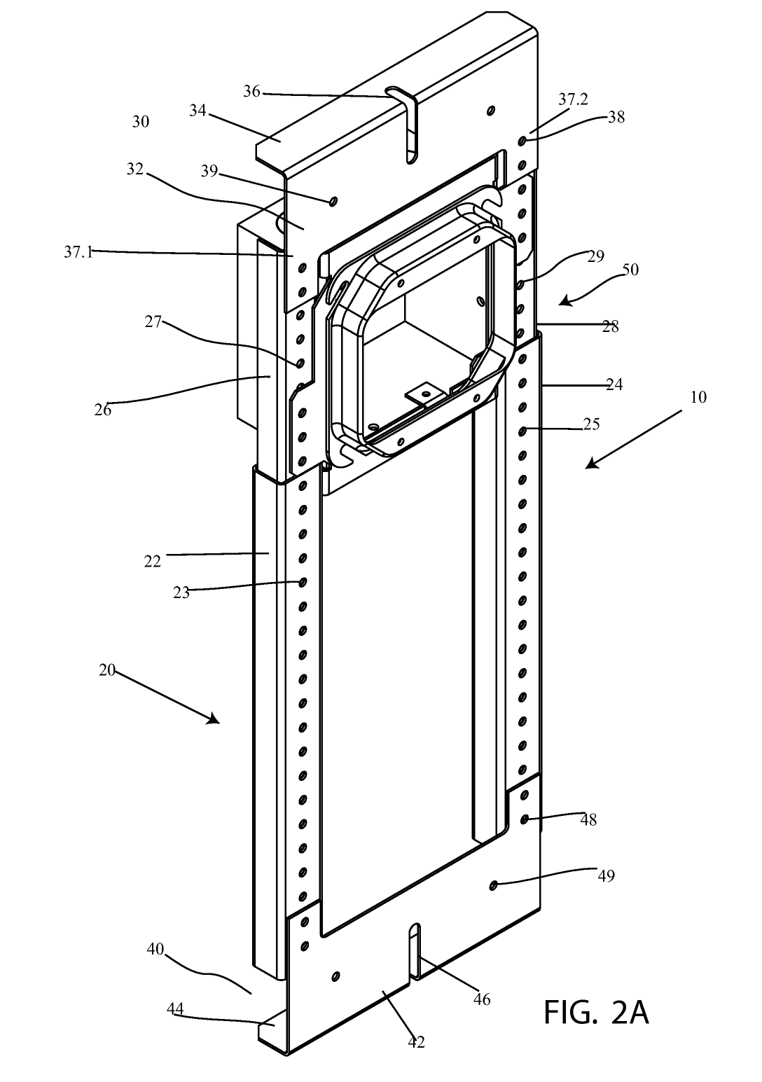

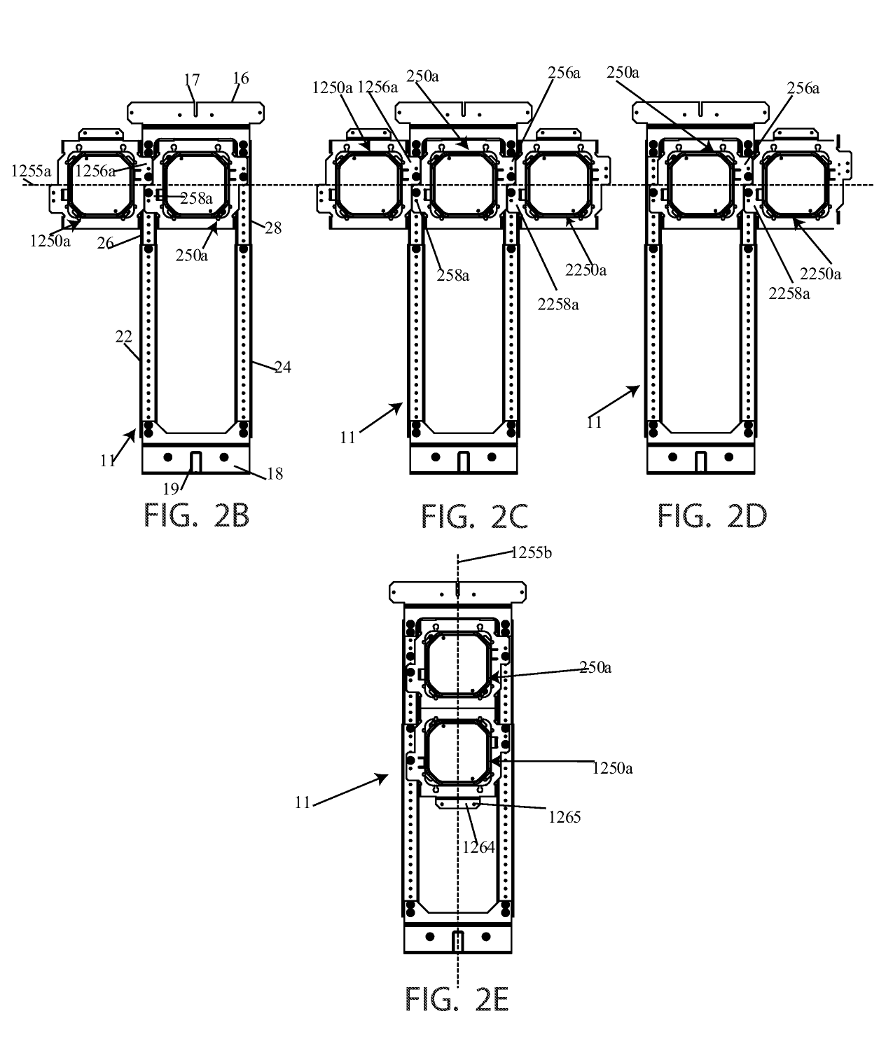

Mounting bracket 250a includes a plurality of angled tabs, 252a, 254a, 260a, and 262a. Angled tabs 252a, and 260a are positioned on first side 281a. Angled tabs 254a, and 262a are positioned on third side 283a. These angled tabs 252a, 254a, 260a, and 262a extend substantially perpendicular to the front planar face of body section 251a. One benefit of these angled tabs is that they provide lateral alignment for the bracket against adjacent objects such as framing members, or against legs or tracks 22, 24, 26, or 28 of an adjustable bracket 20 (See FIG. 2A). These tabs are positioned substantially in the corners of the bracket such that when bracket 250a is coupled to wiring box 150, it provides support against rotation when bracket 250a is coupled to an adjacent framing member such as a wall, floor or ceiling framing member such as a stud/beam/joist. Thus, these tabs are configured for providing lateral support for the mounting bracket against rotation, once the mounting bracket is coupled to an adjacent component.

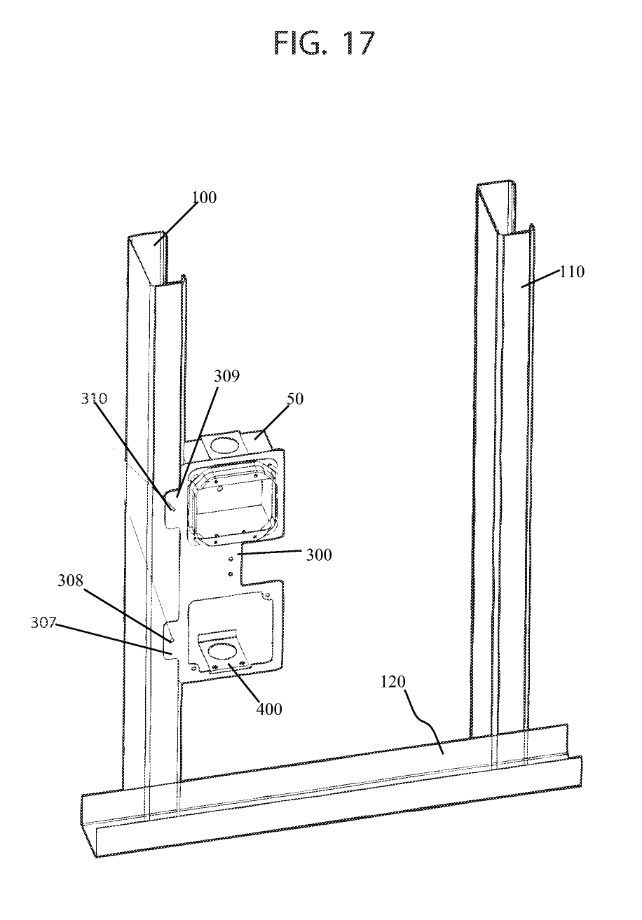

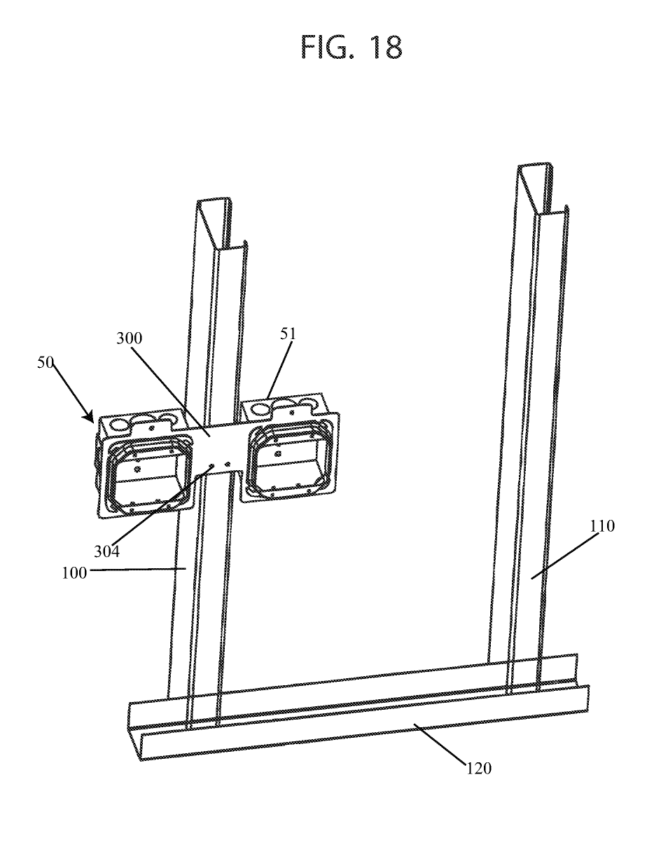

In addition, this bracket includes mounting plate flanges 256a, and 258a. Mounting plate flanges 256a and 258a each include fastener holes 257a, and 259a, which allow this box assembly to be mounted to framing members 100, 110, (See FIG. 17) or to an adjustable bracket system 20 shown in FIG. 2A. In addition, bracket 250a includes connection elements or fastener holes 261a, and 263a, 267a, and 269a for fixing a mounting plate 250a to other components. Flange 256a is positioned on third side 283a, while flange 258a is positioned on first side 281a. Flange 256a is positioned in a complementary manner to flange 258a such that the position of these flanges are such that when two brackets 250a are placed adjacent to each other with side first 281a being positioned adjacent to side third side 283a, flange 258a is positioned adjacent to flange 256a, in a non overlapping manner even when these two brackets are fastened at substantially the same level, or along the same axis. (See FIGS. 2B-2E). These flanges 256a and 258a are positioned in a complementary manner so that when two brackets are positioned adjacent to each other, they form a common substantially co-planar surface for allowing a mud ring to couple to these brackets at substantially the same depth. Flanges 256a and 258a can be positioned in any manner such that they are complementary to each other. In this case, flange 256a is positioned substantially on one side of a center axis 255a of a center hole 253a, while flange 258a is positioned on an opposite side. With this embodiment, the corners of these flanges are beveled as well. FIG. 1A also shows another centering axis 295a which extends transverse to axis 255a, intersecting axis 255a at a center opening point 296a of opening 253a. Thus, when two boxes (See FIG. 2B-2D) are placed adjacent to each other, their flanges would interdigitate with the center points 296a being positioned along a substantially same axis such as a horizontal axis 1255a shown in FIGS. 2B, 2C, and 2D. This positioning provides insertion points for these boxes for electrical components so that these electrical components can be positioned at substantially the same level and at substantially the same depth in the wall.

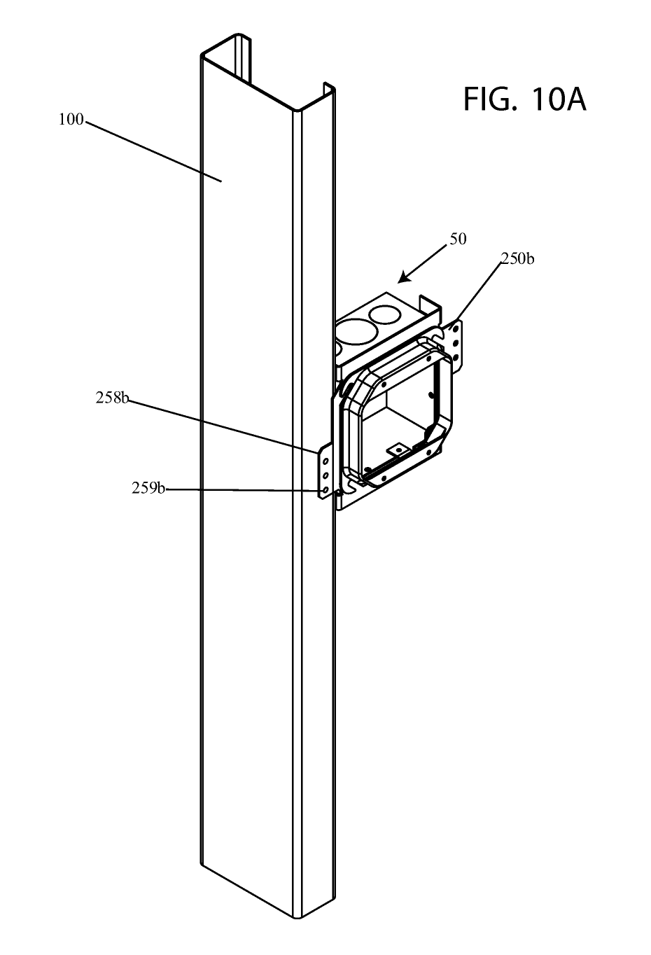

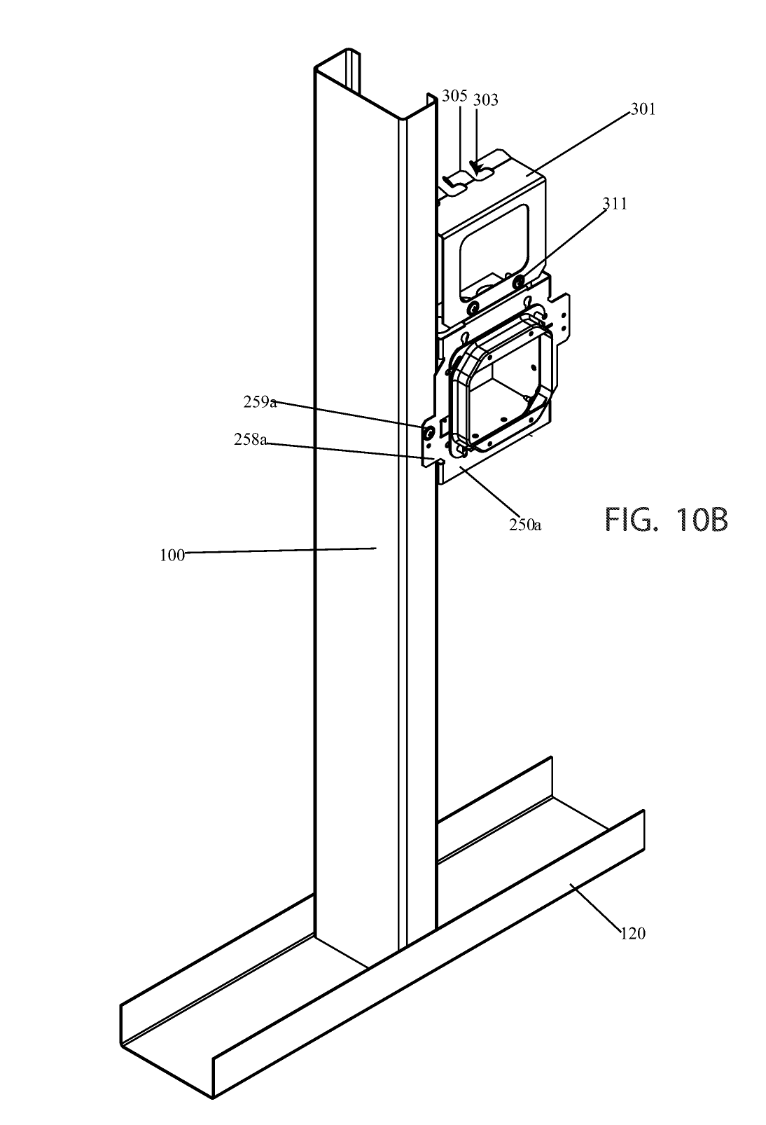

The device can also include an offset tab 264 having at least one fastener hole 265. This tab 264 is formed in a bent manner so as to accommodate an adjacent bracket which can be coupled to it. Essentially, offset tab 264 is formed parallel to body section 251a but along a different plane. An example of an adjacent bracket is shown in FIG. 10B. The bent portion of this bracket allows an adjacent bracket to be coupled flush or substantially flush with a front face of bracket 250a.

Bracket 250a also has a coupling tab 278 having a fastener hole 279 which is used for securing bracket 250a to box 150. Another coupling tab 288, extends substantially perpendicular to body section 251a, and is positioned indented in body section 251a. Tab 288 also has a fastener hole 289 (See FIG. 1C). Because of this indent for coupling tab 288, when coupling a wiring box to bracket 250a, the center of bracket 250a would be offset relative to the position of the center when coupling bracket 250a to a wiring box via tab 278. Thus, because of these two different tabs 278 and 288, bracket 250a can be coupled to a wiring box 150 that is of a different size than what would be required by coupling tab 278. Thus, these two different tabs 278 and 288 provide an example of a means for coupling body section 251a to different wiring boxes such as wiring box 150 having at least two different sizes while still keeping a center point 296a of opening 253a in a center region of a wiring box. (See FIG. 1E).

The front body section 251a of bracket 250a, includes oblong openings 270, 271, and 272 which allow bracket 250a to be rotated onto fasteners 155 and 156 providing a preliminary connection. Once this bracket 250a is rotated onto these fasteners 155 and 156, either tab 278 or tab 288 is connected to box 150 via a fastener. While any fastener can be used, one example of a fastener is a rivet, which fastens bracket 250a to box 150. Next, with this configuration, fasteners 155 and 156 still extend in front of bracket 250a.

A mud ring such as mud ring 350 can then be rotated onto fasteners 155 and 156 to secure this mud ring to box 150 and in front of bracket 250a. With this rotation, connection hooks 353 hook over fasteners 155 and 156, to couple this mud ring to bracket 250a, and box 150. Mud ring 350a is used to provide a mounting interface for one or more wiring devices. In addition, the mud ring can be selected to have any desired depth. This is beneficial because electrical boxes are normally mounted flush with the studs or framing members and covered with wallboard. The depth of the mud ring is selected so the front surface of the mud ring is flush with the front surface of the wallboard. Mud ring 350 includes a base section 351, a ring region 352, connection hooks 353, and a front plate 354. Front plate 354 has fastener holes 355 which allow one or more electrical device such as a light switch, a receptacle or any other type of electrical device to be coupled to this mud ring. With connection hooks 353, mud ring 350 can be rotated to connect to bracket 250a which can have fasteners such as fastener 155 coupled into a hole in bracket 250a such as hole 270. In this case fastener 155 is used to couple mud ring 350 to box 150 and/or bracket 250a, with bracket 250a positioned in between.

Once the device is assembled as shown in FIG. 1B it forms an assembled wiring box and mounting bracket assembly (sometimes referred to interchangeably herein as a wiring component or electrical box) which can be easily mounted in different orientations to multiple different other components.

FIG. 1C shows a back exploded view of the mounting bracket 250a, the mud ring 350 and the wiring box 150 before assembly. This view shows tabs 252a, 254a, 260a, and 262a in greater detail along with tabs 278 having screw hole 279 and tab 288 having screw hole 289. Tab 288 is positioned as indented into body section 251a, via a gap region 290.

With this design, flanges 256a and 258a are formed to allow two adjacent brackets 250a to be placed next to each other so that the flanges 256a or 258a do not overlap (See FIGS. 2B-2E) which allows for a more uniform installation. In addition, tabs 278 and 288 also result in a design wherein bracket 250a, can be secured directly to a wiring box separate from a mud ring such as mud ring 350. Alternately, the mud ring could be secured to the bracket but without a corresponding box. This is useful in an installation where low voltage wiring is to be mounted in a wall and an electrical box is not necessary.

FIG. 1E shows a back view of bracket 250a, which shows tabs 278 and 288 extending back from body section 251a. In addition, an outline of a first wiring box 150 is shown, which can be for example a four (4) inch box. Box 150 would be fastened to tab 278 in the manner described above. There is also an outline of a second wiring box 159 which extends beyond box 150, and which can be fastened to tab 288 and extends into gap region 290. Second wiring box 159 can be a larger wiring box such as a five (5) inch wiring box which provides additional space for storing wires.

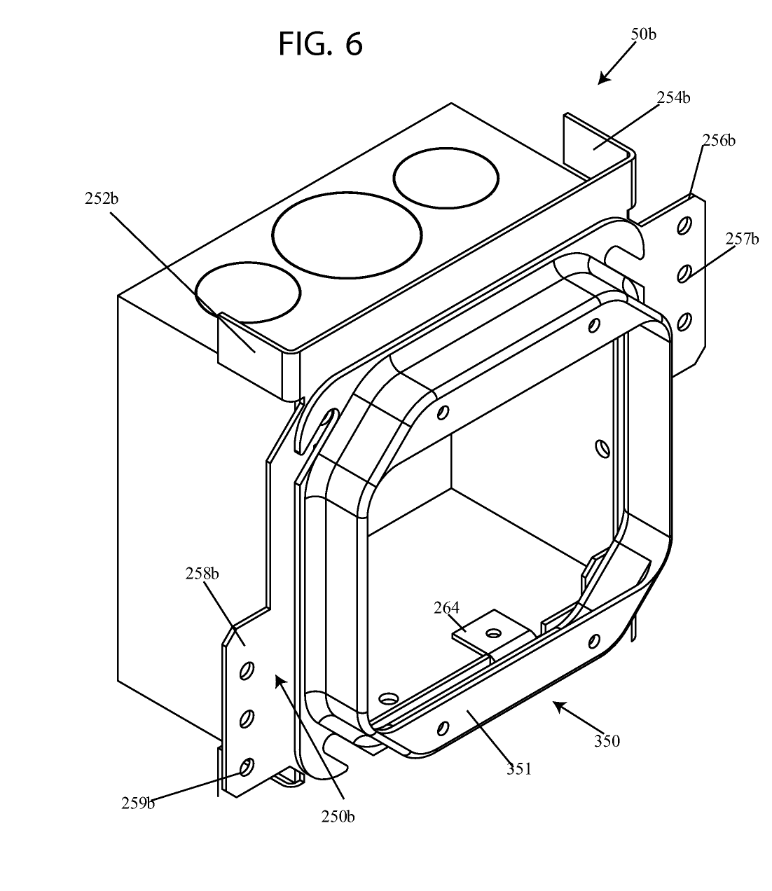

FIG. 2A shows a perspective view of an adjustable electrical component installation system 10 which includes an adjustable bracket system 20 and a box 50. Box 50 is representative of either box 50a shown in FIG. 1B or box 50b shown in FIG. 6 and is in at least one form an electrical box which receives electrical components such as receptacles, light switches, or other known electrical components.

Adjustable bracket system 20 includes an upper and a lower assembly, wherein this design includes legs or track members 22, 24, 26, and 28, wherein these legs or track members can be in any form but in this embodiment are shown as being C-shaped legs. For example, the cross sectional shape can be selected from any one of the following shapes, a channel, a “C”, a “Z”, a hat, a right angle, an acute angle, an obtuse angle, a cylinder, a semi-cylinder, an arc, an “S” or any combination thereof or any other suitable shape as well.

In this particular embodiment these legs are formed as C-shaped so that they hold the telescoped leg in a channel. Each of these legs has connection elements which can be in any form but in this embodiment are shown as holes such as fastener holes. For example, leg or track member 22 has a series of fastener holes 23, leg or track member 24 has a series of fastener holes 25, leg or track member 26 has a series of holes 27, and leg or track member 28 has a series of holes 29. End brackets 30 and 40 are connectable to the associated legs or track members. These end brackets 30 and 40 are angled and can be any form of angled bracket such as 90 degree angled brackets. End bracket 30 comprises a body section 32, and an angled section 34. There is an extended cut out 36 which allows for adjustable connection of these angled brackets via a bolt and also allows for an alignment of this device by serving as a point of reference for a column. End bracket 30 includes legs 37.1 and 37.2 which include connection elements which in this example, are in the form of fastener holes 38. In addition, body section 32 has connection elements which in this example are holes 39 for receiving a fastener such as in the form of a sheet metal screw, a rivet, a nail, a bolt, or any other known suitable fastener.

End bracket 40 is designed in a similar manner to end bracket 30. For example, end bracket 40 includes a body section 42, and an angled section 44. There is also an extended cut out 46, legs 47.1, 47.2 which include connection elements or fastener 48. In addition body section 42 includes connection elements or fastener holes 49 for receiving a fastener. With these embodiments, the term fastener can mean any fastener including an integral track locking tab, a screw such as for example, a sheet metal screw, a bolt, a rivet, a nail, a clamp, a peg, a pin, an anchor, a clasp or any other suitable fastener known in the art. Other means for fastening the components together can include crimping, welding, soldering, brazing, taping, gluing, or cementing.

While FIG. 2A shows one basic configuration, FIGS. 2B, 2C, 2D, and 2E show some of the various different ways that the bracket 250a, can be coupled adjacent to another similar bracket while these brackets are coupled to the adjustable bracket system 11.

For example, FIG. 2B shows two brackets 250a, 1250a being coupled adjacent to each other with flange 258a being position adjacent to flange 1256a in a complementary manner so that these two brackets can be positioned side by side with each other at a same or similar vertical level. FIG. 2C shows a similar configuration showing an additional bracket 2250a having a flange 2258a being positioned adjacent to flange 256a in a complementary manner so that there are three adjustable brackets 1250a, 250a, and 2250a positioned at a substantially similar vertical level, or horizontal plane. FIG. 2D shows a complementary configuration to that shown in FIG. 2B with brackets 250a and 2250a being positioned adjacent to each other on a similar or same horizontal plane. In this view, adjustable bracket system 11 is similar to adjustable bracket system 20 however this bracket system includes different end plates or end brackets 16 and 18. End bracket 16 has an elongated slot 17, while end bracket 18 has a bendable tab 19 which is bendable down to a position wherein this bendable tab 19 can be used as a marker for identifying a location of the adjustable bracket 11 behind a barrier such as a wall board. While particular embodiments show either end brackets 16 and 18, or end brackets 30 and 40, these end brackets can be interchangeable on adjustable bracket 20. In addition, while adjustable bracket 20 shows two sets of tracks with leg or track member 26 telescoping within leg or track member 22, and leg or track member 28 telescoping within leg or track member 24, a single set of legs including just legs or track member 22 and leg or track member 24 can be used for a fixed length bracket such as a bracket having 16 inch framing member spacing. Thus, these track members 22, and 26 form nestable tracks, while track members 24 and 28 form nestable tracks as well. Preferably, the outer track within which the nested track slides is shaped and configured in such a manner so as to result in a captive arrangement; i.e., the inner nested track can slide within the outer nested track but cannot be dislodged laterally. One example of a captive arrangement would be a “C” shaped outer nested track and a “U” shaped inner nested track.

Furthermore, wiring box 150 can be in the form of a standard four (4) inch box. However, because of indented tab 288, a five (5) inch wiring box can be used instead. While the measurements of these boxes are provided as an example, the bracket and the mounting system is not limited to particular dimensions.

In these examples shown in FIGS. 2B-2D, the brackets and their corresponding flanges are positioned so that these flanges such as flanges 256a, 258a, 1256a, and 2258a interdigitate or enmesh with each other so that these flanges are positioned adjacent to each other. The term interdigitate is not meant to require that a single flange be surrounded by other flanges. Rather, interdigitate is to be construed as allowing two different flanges from two different brackets to be positioned adjacent to each other in a complementary manner without overlapping each other.

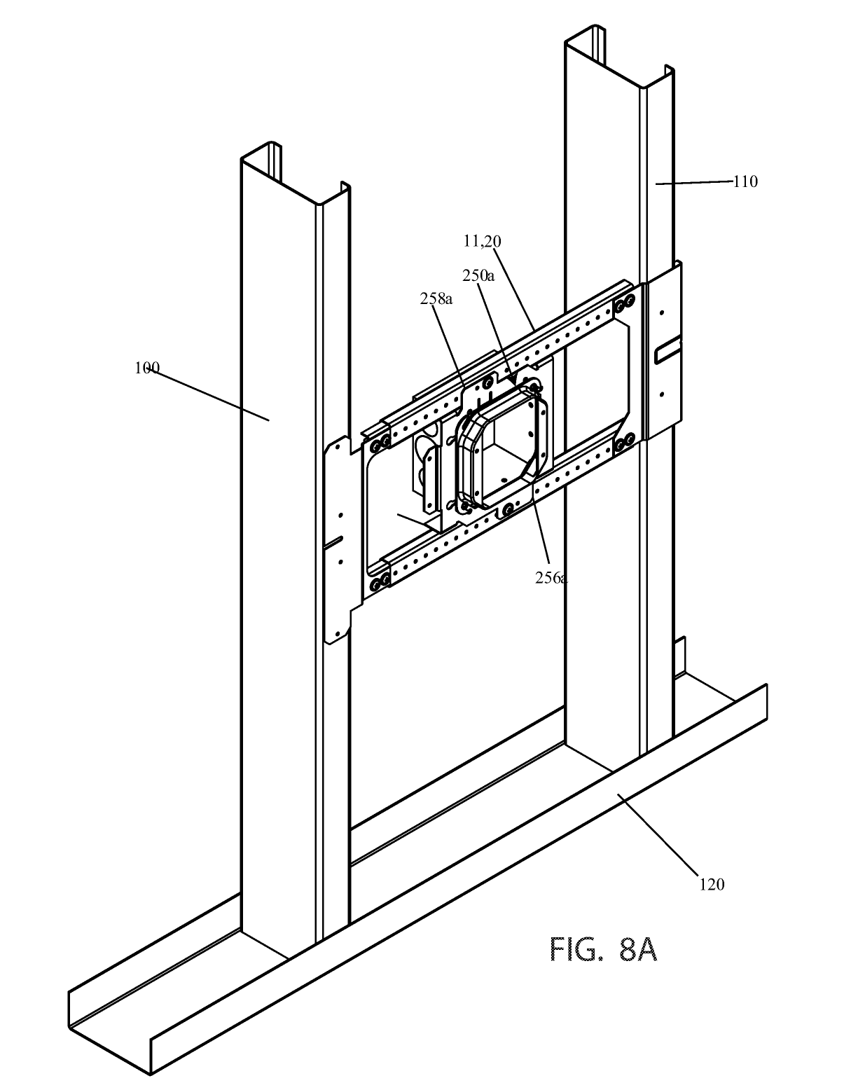

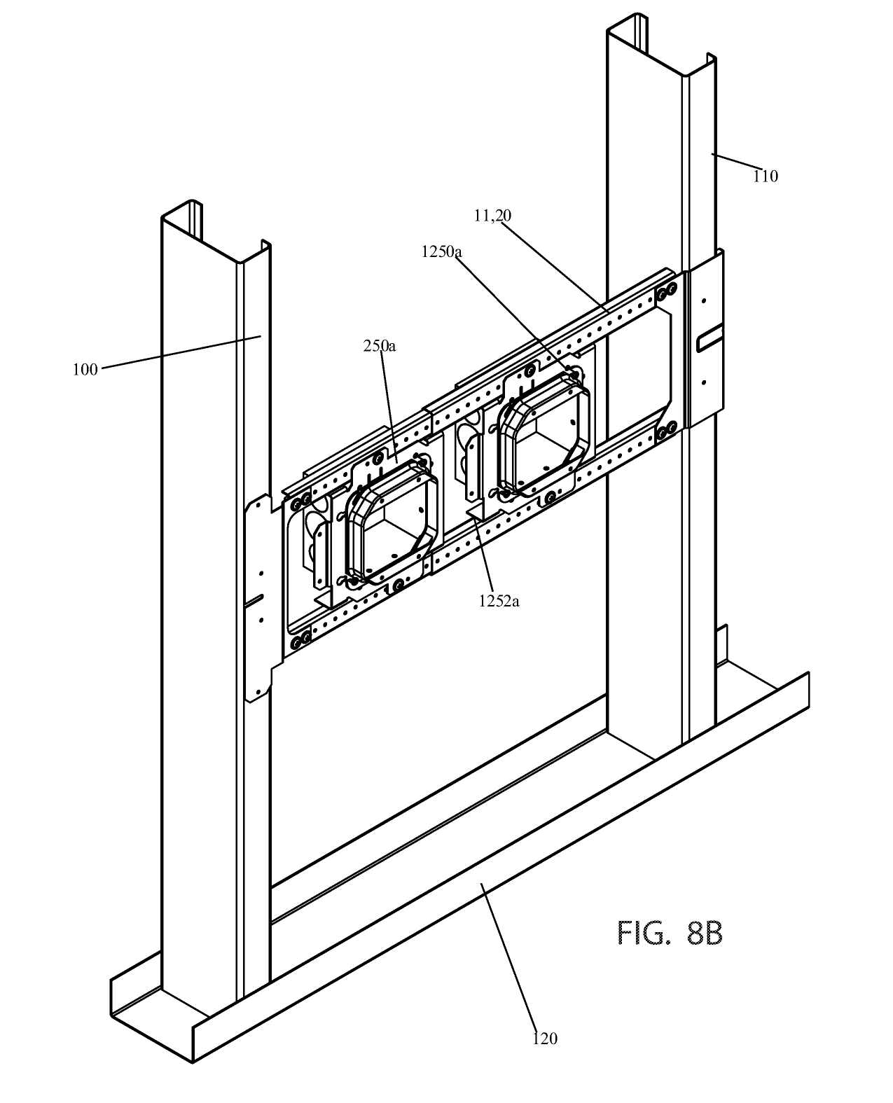

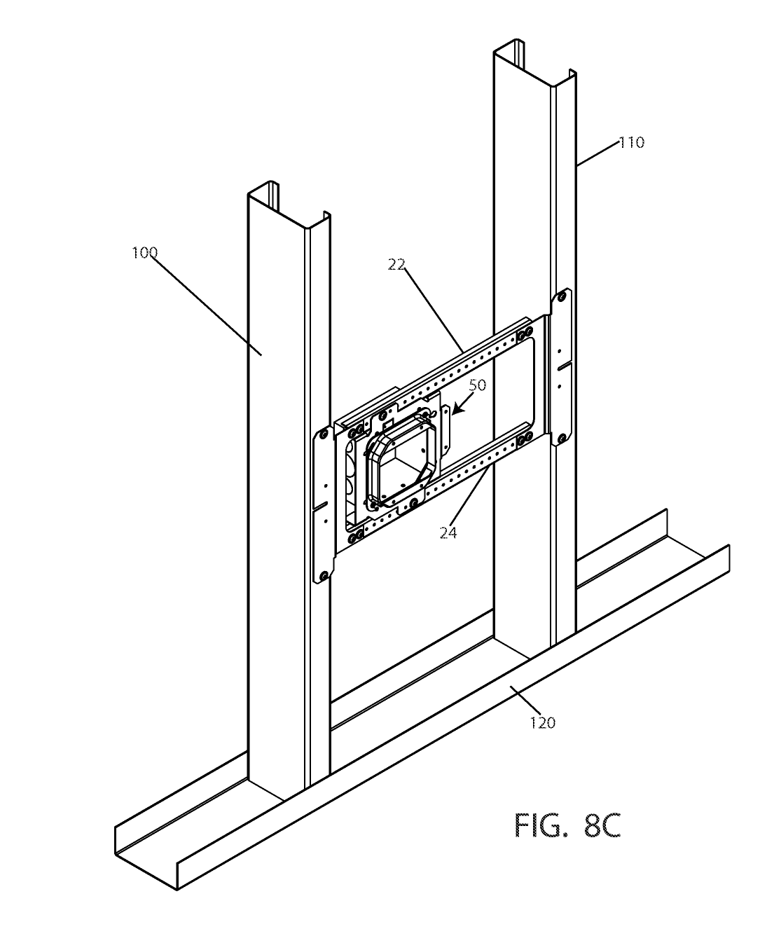

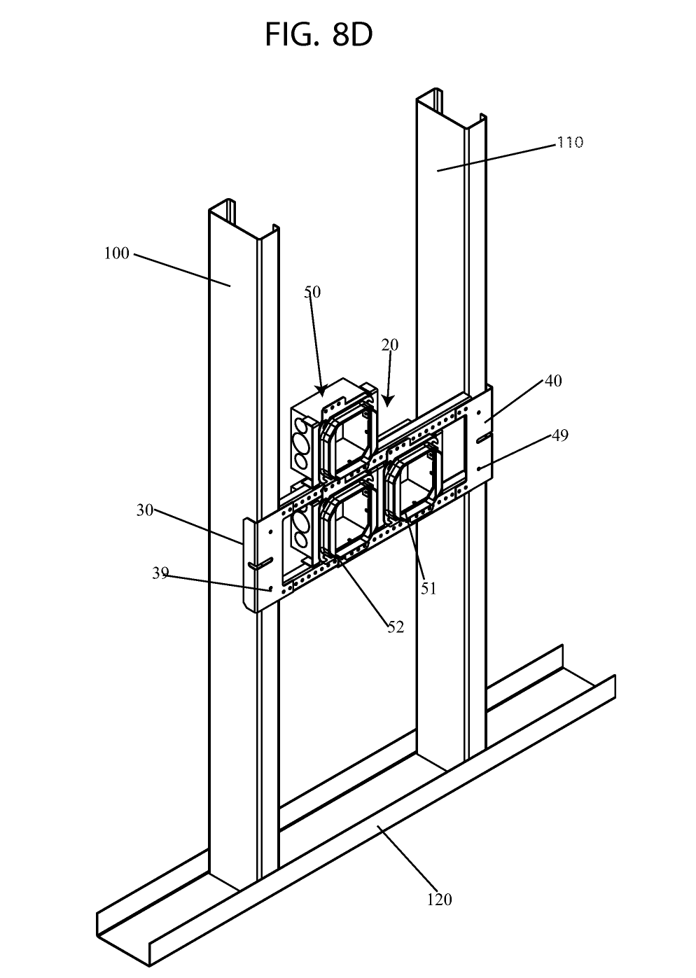

The term complementary flange can be construed as referring to a flange that is configured to fit inside of a gap or opening such as a non-flanged region on a side of a bracket that is adjacent to another flange on another bracket. An example of a complementary flange is flange 1256a shown in FIG. 2B which extends along substantially the same vertical axis 1295a as flange 258a so that two different flanges from two different brackets can be coupled to the same track or alternatively to the same framing member. While this example is shown in a vertical orientation, this configuration can be used for coupling along a horizontal axis as well such that two flanges would extend along substantially the same horizontal axis as shown in FIG. 8D.

One benefit of the configuration of these flanges is that it allows multiple brackets such as brackets 250a, 1250a, and 2250a to be placed adjacent to each other on a single adjustable bracket or on a single track or framing member with no overlapping flanges and with a center region or point 296a of the bracket opening, such as bracket opening 253a being positioned along a substantially similar axis. For example, the openings of brackets 250a, 1250a, and 2250a, are all positioned on a substantially similar level such as a horizontal level so that they bisect an axis line 1255a, which in this case is a horizontal axis to give the appearance that these boxes are at the same level as each other relative to a surface such as a floor. In addition, because flanges 256a and 258a and flanges 1256a, and 2258a do not overlap, the front contact surfaces of brackets 250a, 1250a, and 2250a all extend along a substantially similar plane forming a substantially even contact surface for mounting a cover, such as sheet rock, or wall board. In this way, the contact surface of these brackets do not form an uneven contact surface for the associated wall board. Thus, these flanges can be used as a means for coupling a bracket such as bracket 250a to an adjacent support, adjacent to another bracket such as bracket 1250a so that a bracket such as bracket 250a and the other bracket 1250a have contact surfaces positioned along a substantially similar plane, and have openings with a center region extending along a substantially similar horizontal axis such as axis 1255a. In addition, since the flanges do not overlap, each flange extends over the majority of the width of the associated framing member. This allows the device to be more securely mounted to the stud or framing member. If the flanges did not interdigitate, two adjacent flanges would either overlap creating a bulky protrusion behind the finish wallboard or have to share the width of a single stud or framing member. This may result in a less secure installation.

FIG. 2E shows brackets 250a and 1250a being positioned adjacent to each other along another axis such as vertical axis 1255b.

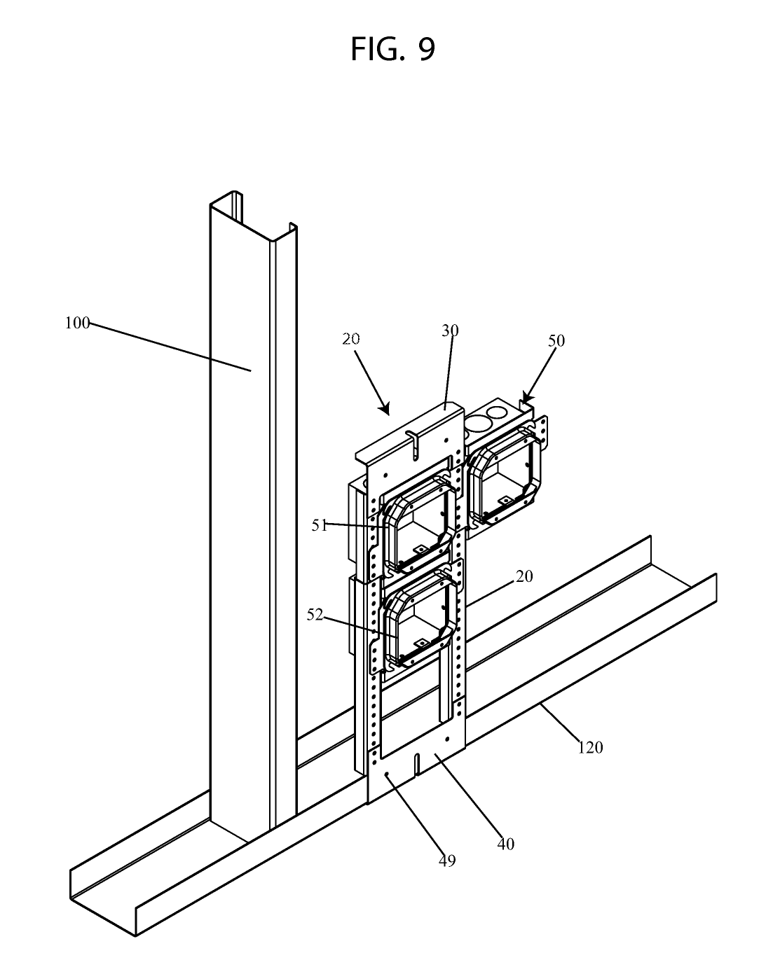

While the terms vertical plane, vertical axis, horizontal plane and horizontal axis are used above, the device can be used in any orientation as shown for example in FIGS. 8A-9.

In this case as shown in FIGS. 2B-2E all of these brackets 250a, 1250a, and 2250a can be coupled to an associated mounting system 20 as well as to associated wiring boxes as well.

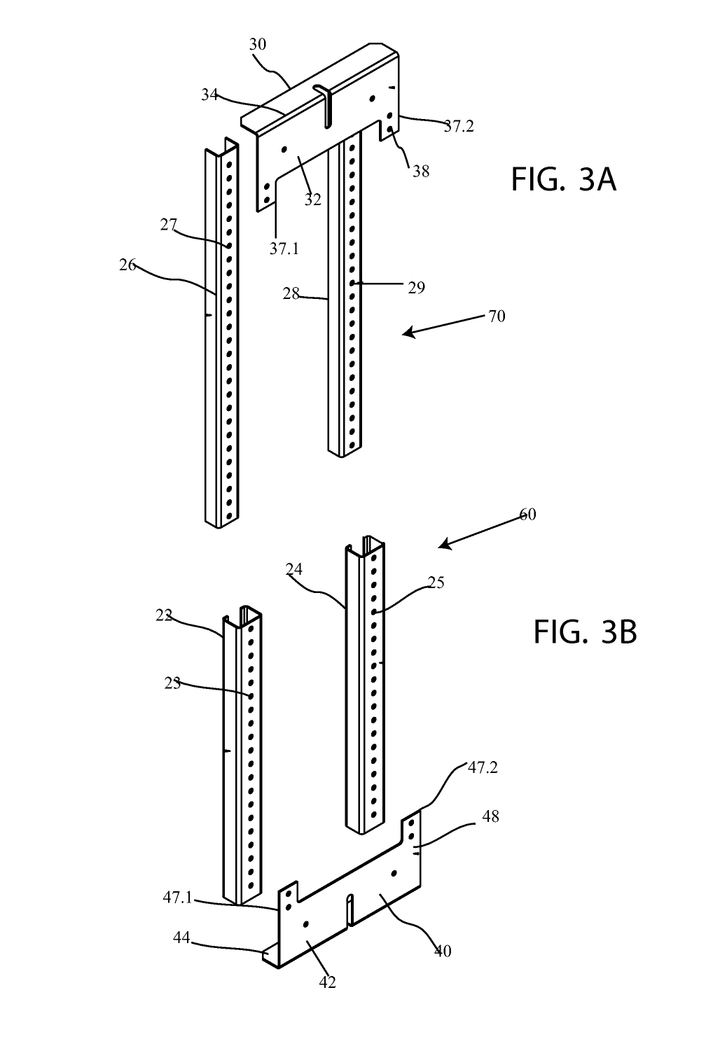

FIGS. 3A and 3B show the exploded views of components of FIG. 2A. For example, end bracket 30 connects to legs or track members 26 and 28 via fasteners inserting into holes 38 and then into holes 27 and 29. These coupled components form the upper assembly 70. In addition, end bracket 40 is fastened to legs or track members 22 and 24 via fasteners such as sheet metal screws inserting into holes 48 and then into associated holes 23 and 25. This then forms the lower assembly 60.

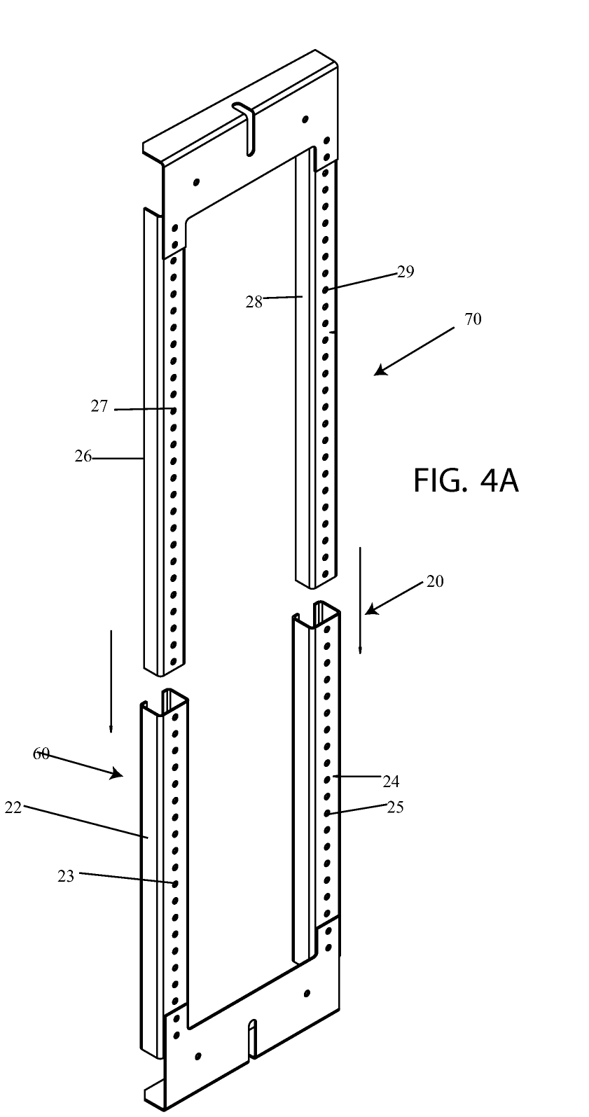

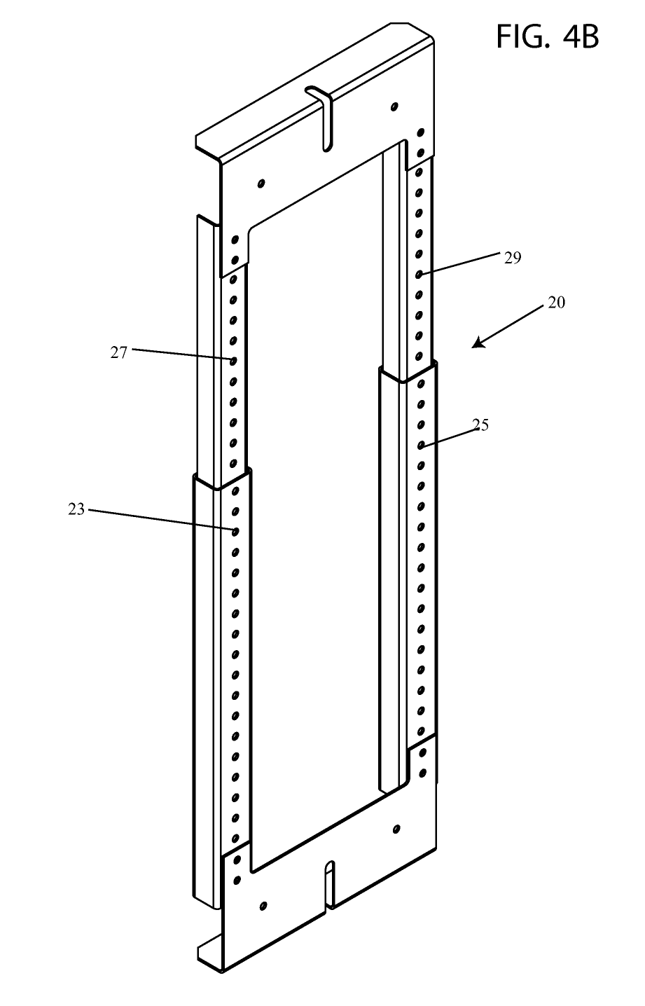

FIG. 4A shows the adjustability of adjustable bracket 20 which shows how upper assembly 70 inserts in a telescoping, or slidable manner to lower assembly 60. This then creates a length adjustability for the adjustable bracket. Each of the associated series of holes 23, 25, 27 and 29 are formed as sets of holes that are spaced equidistant or substantially equidistant from each other so that when legs or track members 26 and 29 slide into legs or track members 22 and 24 these holes line up and allow for the connection via fasteners such as sheet metal screws.

FIG. 4B shows the adjustable bracket system in the assembled state wherein its length can be set by inserting fasteners such as sheet metal screws into the appropriate connection elements or holes 23, 25, 27 and 29 wherein in one method, a fastener such as a screw would then insert into hole 23, through this hole into a matching hole 27, while another fastener would insert into hole 25 and then into hole 29.

FIG. 5 shows an exploded view of an electrical box which was shown in FIG. 1. In this case, there is a wiring box section 150, a mounting plate 250b, and a mud ring or a plaster ring 350. Wiring box section 150 can be formed from any known type of electrical box section and includes fastener hole sets 151a, 152, 153, and 154 for receiving connecting fasteners. In addition additional fasteners 155 and 156 are designed to allow a locking fastener such as a screw to insert therein so that the mounting plate can be connected thereto. In addition, this fastener can be placed such that it extends out to receive flanges or connection hooks 353 which are used to lock ring 350 to mounting plate 250b (See FIG. 6).

Mounting plate 250b includes a body section 251b, and corner angled brackets 252b, 254b, 260b, and 262b. In addition, this bracket includes mounting plate flanges 256b and 258b. Mounting plate flanges 256 band 258b each include respective fastener holes 257b and 259b which allow this box assembly to be mounted to framing members 100, 110 or 120 or to the adjustable bracket. In addition, body 251b of bracket 250b includes connection elements or fastener holes 261b and 263b for fixing mounting plate 250b to additional components. Once the device is assembled, (See FIG. 6) it forms an electrical box which can be easily adjustably mounted in different orientations to multiple different other components.

Plaster ring 350 has a ring section 351, a front plate section 354 coupled to ring section 351 and fastener holes 355 coupled thereto for allowing an electrical device having for example a strap to couple thereto. As shown in FIG. 6, a connection tab 264b is used to connect mounting plate 250b to box 150.

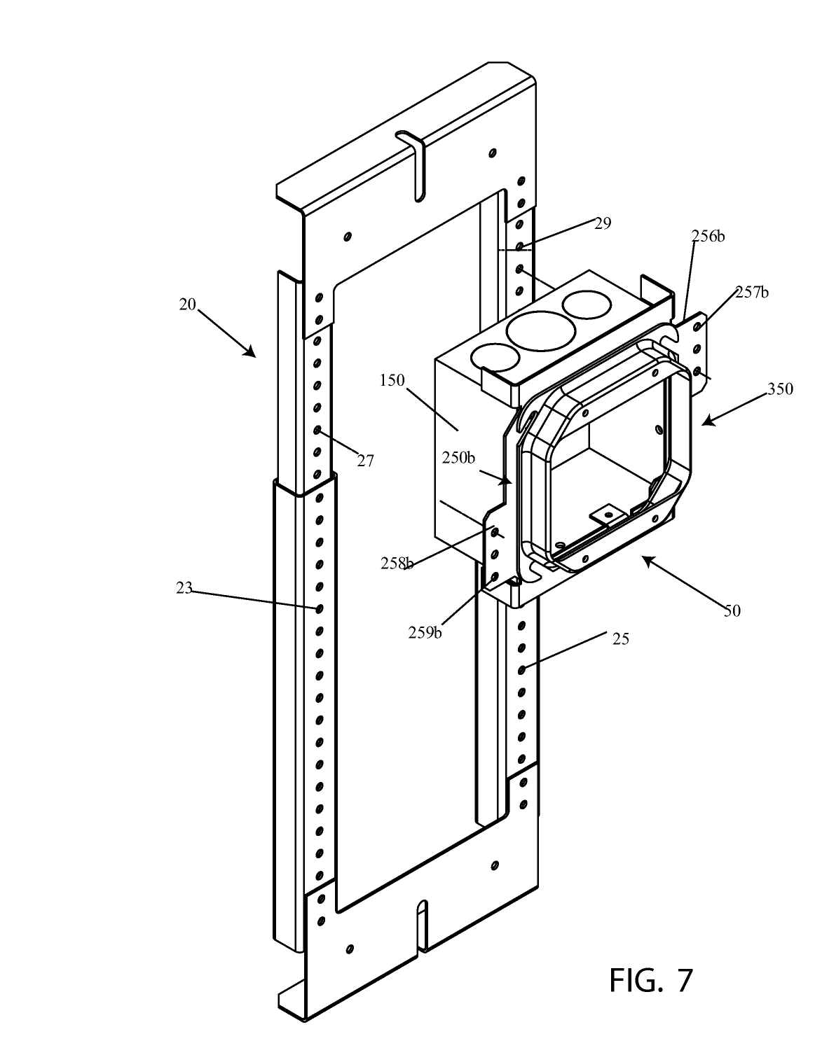

For example, FIG. 7 shows a perspective view of box 50 which is set to be coupled to adjustable bracket 20. Holes 257b and 259b are disposed on flanges 256b and 258b respectively to allow a user to insert a fastener such as a sheet metal screw therein to connect box 50b to adjustable bracket 20. In this case, fasteners or screws would insert through holes 257b, and 259b and then be inserted into corresponding holes 23, 25, 27 or 29.

FIG. 8A shows a horizontal extension of an adjustable bracket 20, having a bracket 250a coupled thereto via a fastener such as screws. While screws are shown, any other known suitable fastener can be used. Adjustable bracket 20 is coupled to substantially vertically extending framing members 100 and 110 which are coupled to a base or floor framing member 120. Flanges 256a and 258a are coupled to adjustable bracket 20 via these fasteners while tabs such as tab 252a is also used to provide support against rotation by being positioned adjacent to a track 22 on adjustable bracket 20.

FIG. 8B shows a similar configuration with an additional bracket 1250a coupled to adjustable bracket 20 via flanges 1256a, and 1258a being coupled to fasteners such as screws or other known fasteners. Again a tab 1252a is used to provide support against rotation for additional bracket 1250a in a manner as described above.

FIG. 8C shows a perspective view of another embodiment including non nested tracks. Instead, with this design there are tracks 22 and 24 which are used as a system for a set length. As shown there is an electrical box 50 which is representative of electrical boxes 50a, and 50b which is coupled to these non nested tracks 22 and 24.

FIG. 8D shows another form of coupling of these components. For example, there is shown three electrical boxes 50, 51, and 52 wherein each of these modified adjustable electrical boxes are connectable to the adjustable bracket either between the track members of the adjustable bracket 20 as shown by electrical boxes 51 and 52, or extending outside of the region between the legs of the electrical boxes as shown by electrical box 50. The mounting of theses boxes occurs via lining up the spaced holes and then inserting fasteners such as sheet metal screws or any other known fasteners to fasten these components together. In addition, in this view, the adjustable bracket 20 is adjustable in length via its telescoping features discussed above so that it is easily adjustable across a span of framing members 100 and 110 to fit any type of construction, and at any level above a floor or floor framing member 120. As shown, angle brackets 30 and 40 are used to line up adjustable bracket 20 so that it extends in a substantially horizontal manner, or at least substantially perpendicular to framing member 100 and 110.

FIG. 9 shows adjustable bracket 20 which is coupled to floor framing member 120 via fasteners inserting into coupling elements, or fastener holes 49 in end bracket 40. The angled end 44 (See FIG. 2B) of angle bracket 40 is inserted underneath floor framing member 120 to provide further stability. Adjustable bracket 20 then extends vertically and is adapted to receive multiple electrical boxes 50, 51, and 52 which are secured via fasteners fastening the flanges of the mounting plates to the adjustable bracket 20.

FIG. 10A is a perspective view of another way to attach the electrical box component 50. In this way, flange 258b, is fastened to a wall framing member 100 via fasteners such as sheet metal screws or any other known fasteners inserting through holes 259b.

FIG. 10B is a perspective view of a configuration using bracket 250a and a strain relief or cable guide 301. Cable guide 301 is coupled to additional tab 264 via fasteners such as screws 311 or any other known fasteners inserting through holes on cable guide 301 and into fastener holes 265 on additional tab 264. In addition, as shown in this view, flange 256a having fastener holes 257a is coupled to a vertical framing member 100 via a fastener such as a screw or any other known fasteners. While screws are shown as fasteners, other known fasteners can be used as well such as bolts, rivets, slugs, nails, or any other known fasteners which would be suitable for coupling a bracket to an adjacent framing member.

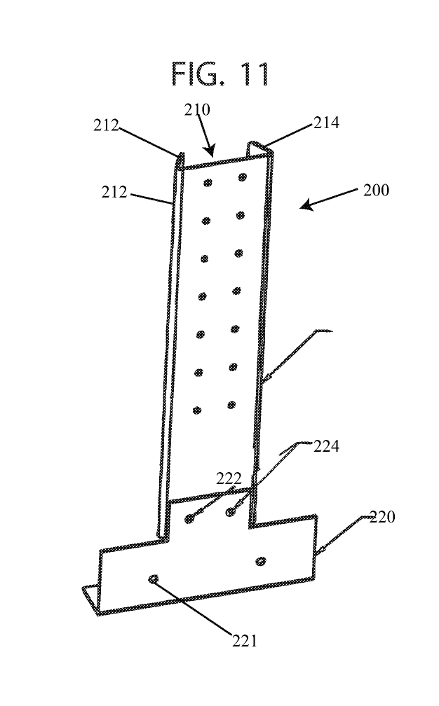

FIG. 11 shows the design of a uni-stand electrical box mounting system 200. It comprises a bottom channel 210 having two angled flanges 212 and 214 forming a channel. The angled flanges can be angled at any desired angle, preferably less than 90 degrees to create a captive arrangement, but in this case each channel's flanges are angled 60 degrees (although a broad range of acute angles would be suitable) relative to the front faceplate. The angled nature of these channels keeps one channel slidably disposed inside another channel in a captive arrangement when the channels are coupled together.

This bottom channel can be connected to a base bracket 220 which can be kicked under a wall stud or framing member such as wall framing member 120 during installation. Bottom channel 210 has approximately 60 degree bend so that other channels can be nested into them for a telescoping function. The channels 210 and 230 are nested together and can be locked together by connection elements or fasteners such as a sheet-metal screw on each side. For example, bottom channel 210 is attached to base bracket 220 using fasteners such as sheet-metal screws via connection openings for interfaces 222 and 224. This base bracket has a fluted bottom to avoid interference with a stud fastener. For vertical applications, an electrical box 50 can be mounted on a top channel such as channel channels 210 or 230 using connection elements or fasteners such as sheet-metal screws.

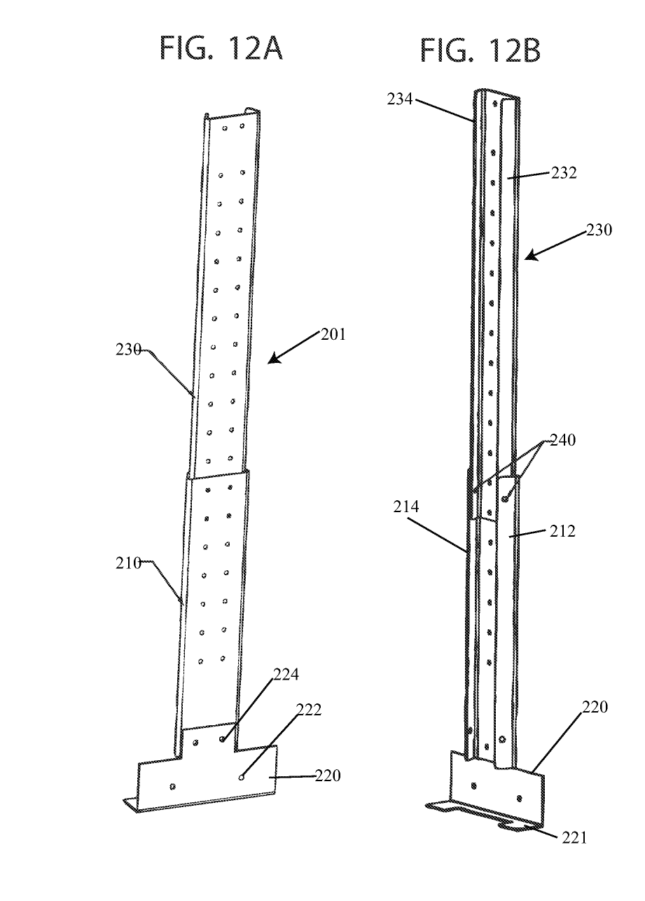

FIGS. 12A and 12B show the connection of these bottom and top channel brackets connecting to each other. For example, top channel bracket 230 telescopes or slots within bottom channel bracket 210 to form a telescoping system 201. Each angled or flanged section of the top bracket 232 or 234 forms a locking channel such that this bracket can be slid up or down as well as be locked in a horizontal manner as well. Connection holes 240 are used to selectively adjust the height or positioning of this upper channel 230 the verses of the lower channel 210.

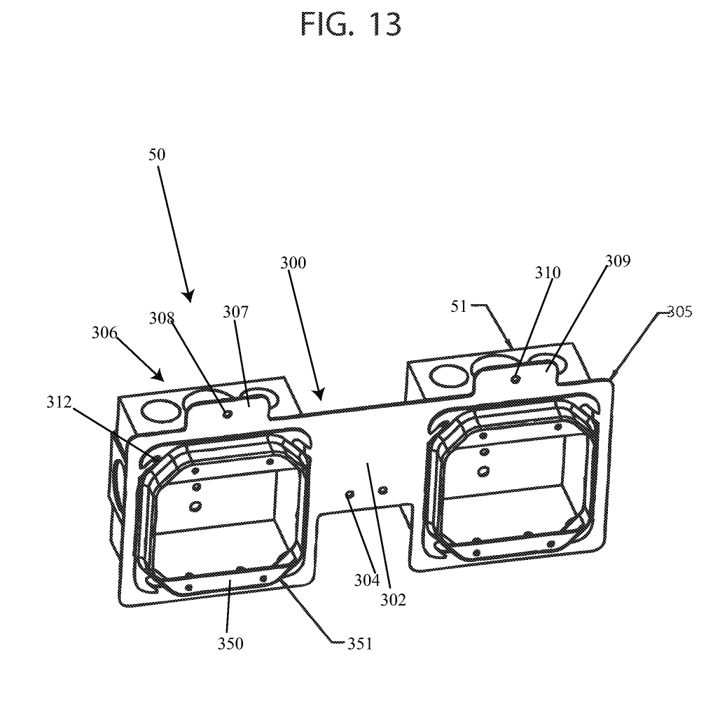

Once the positioning of these channels is set, an electrical box mounting bracket can be connected as well. As shown in FIG. 13, there is electrical box mounting bracket 300 which is used to couple two electrical boxes 50 and 51 together. This electrical box mounting bracket 300 is a dual bracket design wherein there are at least two ends 305 and 306 and with end 306 having tab 307 and fastener hole 308 while end 305 has tab 309 and fastener hole 310 connected together via a body section 302. Bracket 300 also includes connection elements or fastener holes 312 which are for receiving a connection element or fastener such as a screw for coupling a mud or plaster ring 350 thereto. Integrated into body section 302 are connection elements or fastener holes 304. These fastener holes 304 are for mounting to either one of the channels 210 or 230 or to a framing member as well. This connection can be done via any tight connection elements such as for example sheet-metal screws. The box mounting bracket 300 is designed to allow users to mount standard electrical components such as 4 inch electrical boxes if necessary, or a combination of a 4 inch electrical box and a low voltage through box as well. Other types of electrical boxes can also be attached to this type of bracket. Bracket 300 connects behind the mud ring or plaster ring 350 on a electrical box. This allows users to remove the mud ring without disturbing the box thus allowing the installer to remove the mud ring without the electrical box becoming loose or dislodged.

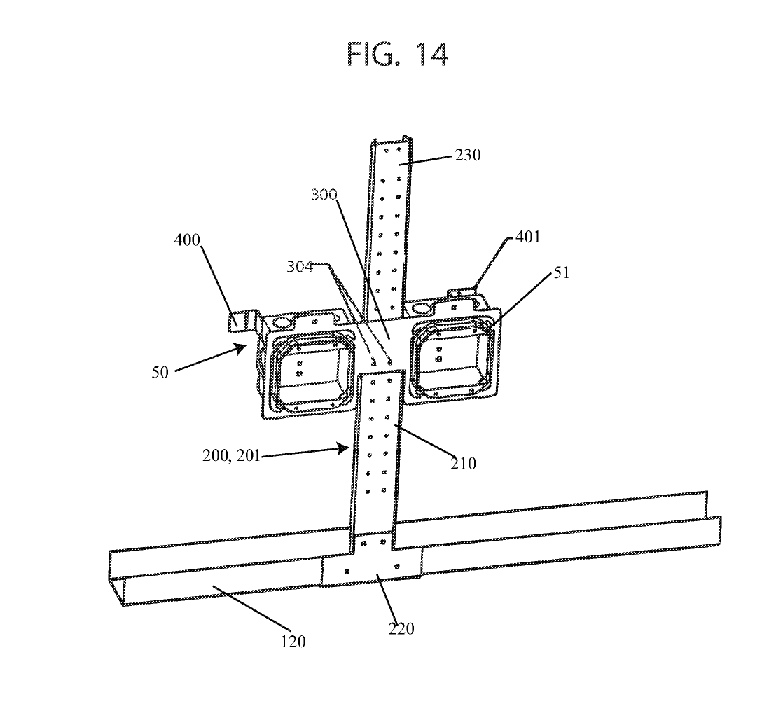

FIG. 14 shows the electrical box mounting bracket 300 which is connected to bottom channel 210 or top channel 230 via connection elements or fasteners such as sheet-metal screws through connection or fastener holes 304. As shown, there are two electrical boxes 50 and 51 connected to box mounting bracket 300. Base bracket 220 is also shown as connected with floor framing member 120, wherein this connection can be via fasteners such as sheet-metal screws as well, or any other type of connection element. Connected to this box mounting bracket 300 is a spacer bracket 400 forming a far side support bracket for determining sheet rock depth. Multiple electrical box mounting brackets can be mounted on each of these columns or channels 210, 230 so that the user can have multiple electrical boxes in a particular position. Box 51 also includes a spacer bracket 401 as well.

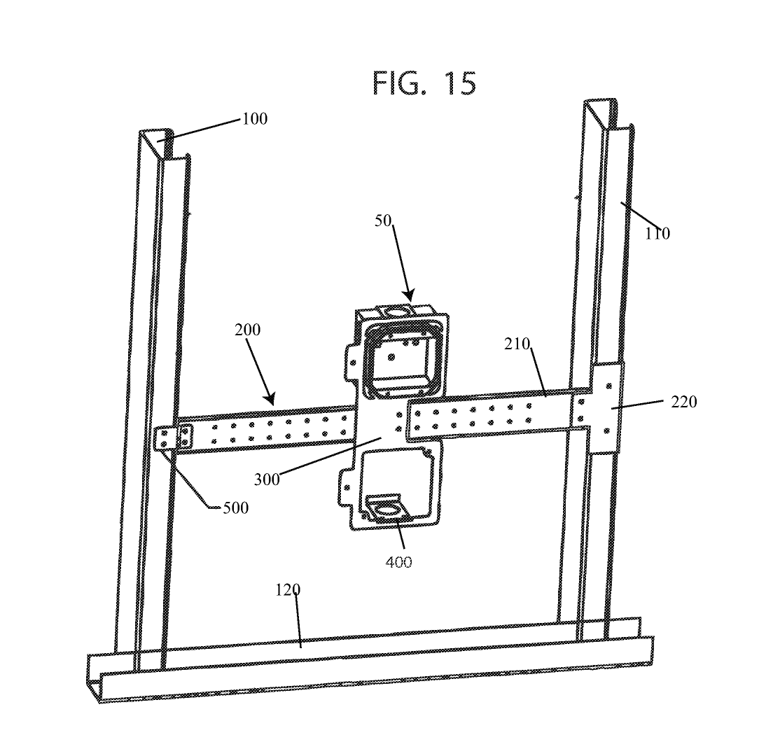

As shown in FIG. 15, the system can be rotated 90 degrees to form a horizontally adjustable bracket as well. In this case, the system can be mounted between vertically oriented framing members 100 and 110 via base bracket 220 coupling to column 110 and coupling bracket 500 coupling to column 100. The coupling of these elements can be via any type coupling elements or fastener such as sheet-metal screws. As shown in this view, spacer bracket or far side support bracket 400 is shown as connected to electrical box mounting bracket 300 and extending back to a back wall. This spacer bracket or far side support bracket 400 prevents the electrical box from being pushed back into a wall by providing support against the far wall. During implementation, far side support bracket 400 can have different bend lines at different lengths to accommodate different back depths. This allows unique adjustability for the far side support bracket 400. Alternatively, the electrical boxes that are used with this system may optionally be fastened directly to the building framing members such as studs rather than being mounted on the brackets or channels as described above.

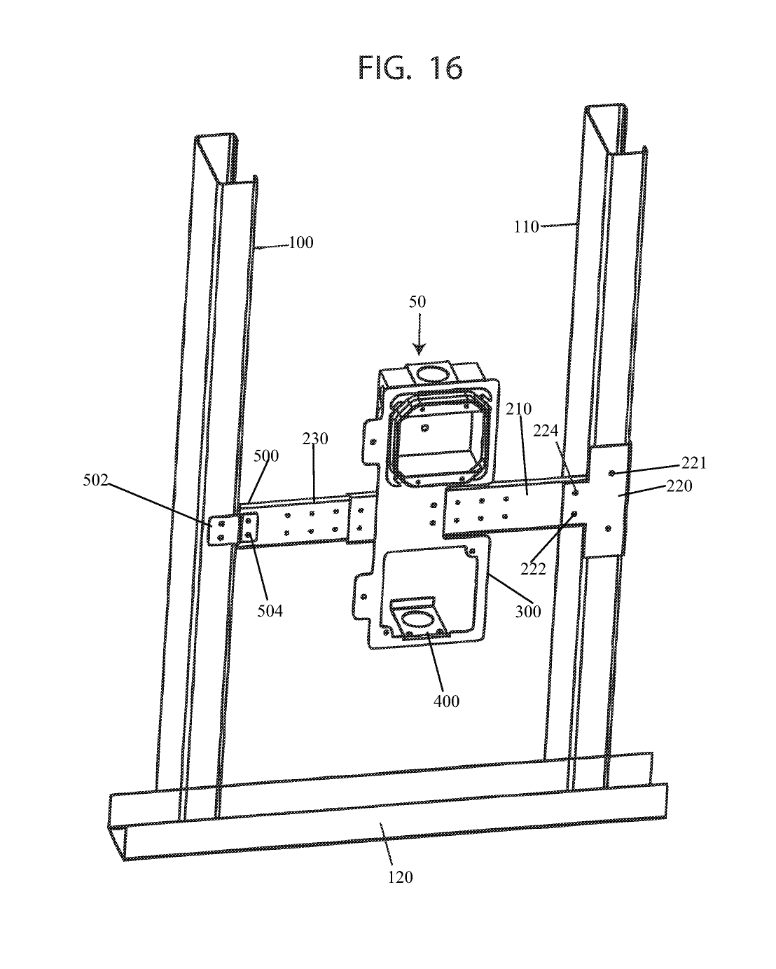

FIG. 16 shows a variation on the system shown in FIG. 15. With this design, brackets or channels 210 and 230 are connected together such that channel 230 is telescoping into channel 210 as shown in FIGS. 12A and 12B. This combination of telescoping brackets or channels is connected to electrical box mounting bracket 300 in the manner discussed above. As shown, channel 210 is connected to framing member 110 via angled base bracket 220 via any known connection elements or fastener such as sheet metal screws connecting through connection elements or holes 221, while bracket 220 is connected to bracket 210 via fasteners such as screws or connection elements connecting through holes 222 and 224. At the opposite end, coupling bracket 500 which includes coupling holes 502 and 504 is for coupling channel 230 to column 100 via any known connection elements or fasteners such as sheet metal screws.

As shown in FIG. 17, this electrical box connection bracket 300 can also be connected directly to vertically oriented framing members such as framing members 100 or 110 via connection holes or connection elements 308 and 310 which are connected to flanges 307 and 309 respectively. In this way, one connection bracket user can quickly connect and install multiple electrical boxes or multiple electrical installation components. As shown in this view, this embodiment is designed for vertical applications, wherein the electrical box mounting bracket 300 can be mounted on column or u-shaped channel 100 using fasteners or connection elements such as to sheet-metal screws.

As shown in FIG. 18 the entire device can be rotated 90° and then mounted or connected to an individual stud, or framing member, 100 via connection elements or fasteners fitting through fastener holes 304 connecting the bracket to a framing member.

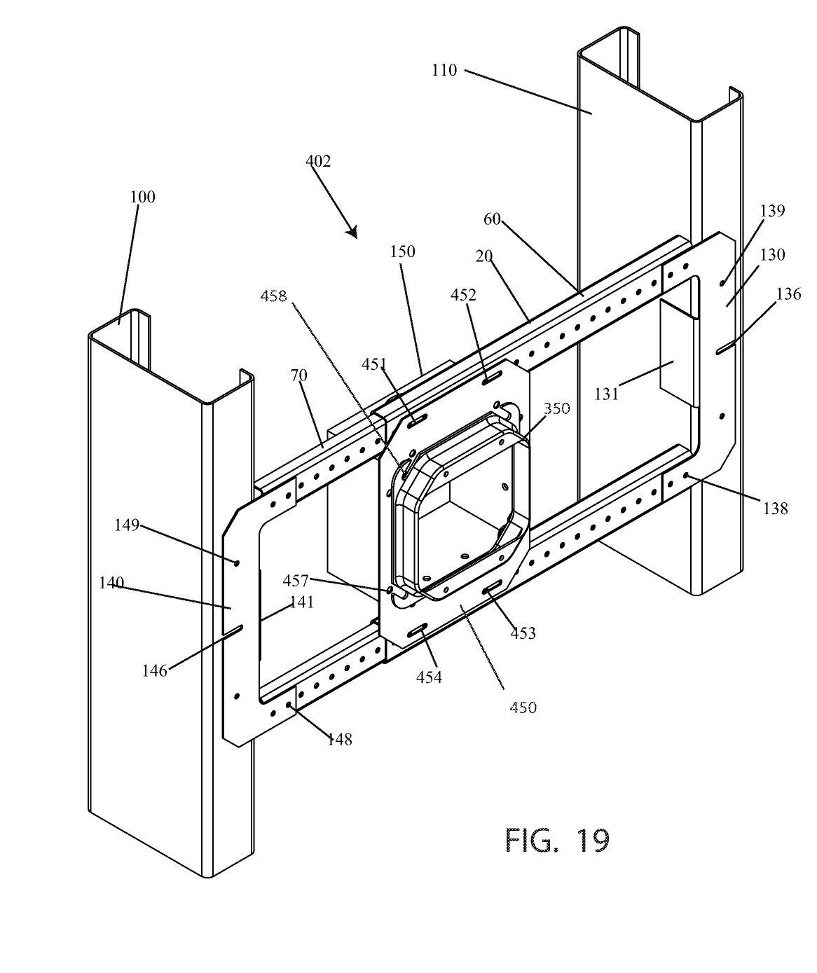

FIG. 19 shows another alternative embodiment relates to a different mounting plate 450 for the electrical box 150. In this case, the mounting bracket 450 has four slots 451, 452, 453 and 454 which are elongated which allow a user to have some lateral adjustability regarding the coupling of this mounting bracket 450 to an adjustable bracket 20. For example, in this view mounting bracket 450 is shown coupling to assembly section 60, while assembly section 70 telescopes inside of assembly section 60. The coupling of this mounting bracket 450 results in fasteners such as screws extending through bracket 450 and into both assemblies 60 and 70 to result in a fixing of a length of adjustable bracket 20. Mounting bracket 450 also has a series of fastener holes 457 for receiving fasteners for allowing a mud ring 350 to be mounted on these fasteners via the corresponding connection hooks 458.

In addition, end brackets 130 and 140 are coupled to respective ends of sections 60 and 70. End bracket 130 includes a leveling and setting flange 131 which can also be known as a squaring tab, a leveling notch or slot 136 as well as holes 138 for connecting the bracket 130 to adjustable bracket 20 while holes 139 are for connecting bracket 130 to vertical framing member 110. End bracket 140 also includes a leveling or setting flange 141, a notch or slot 146, along with fastener holes 148 for connecting this end bracket 140 to adjustable bracket 20, while fastener hole 149 is for connecting end bracket 140 to framing member 100.

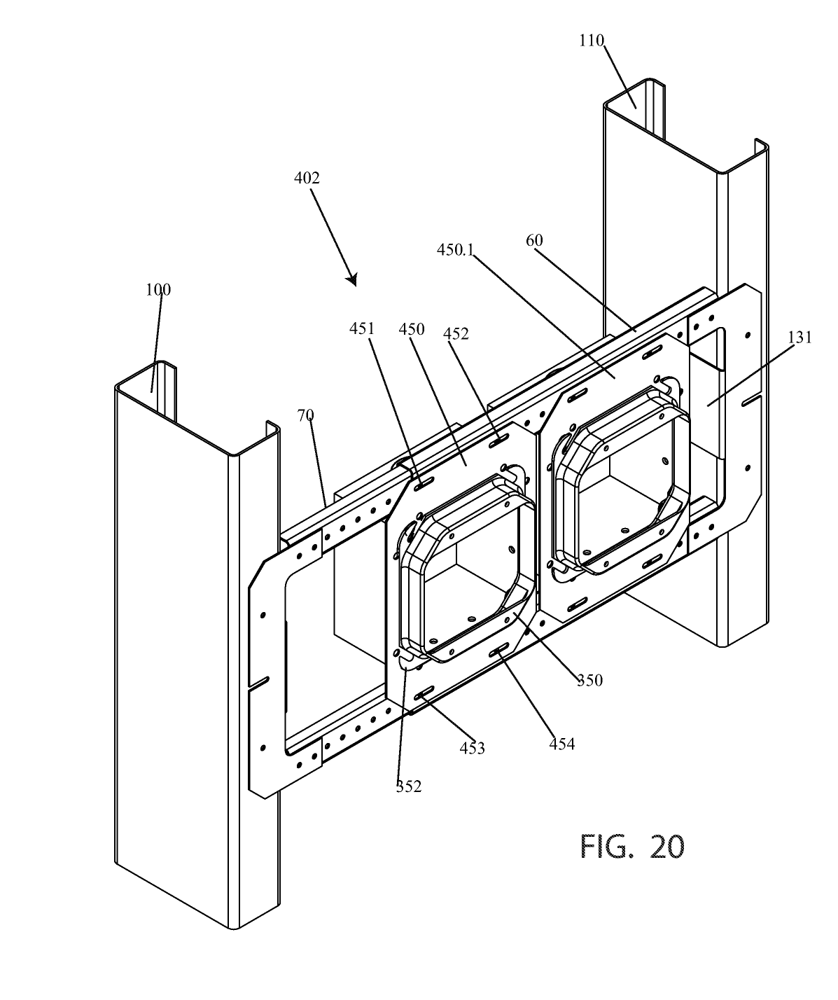

FIG. 20 shows the use of two mounting plates 450 and 450.1 which are each coupled to adjustable bracket 20. Mounting bracket 450.1 is substantially identical to mounting bracket 450.

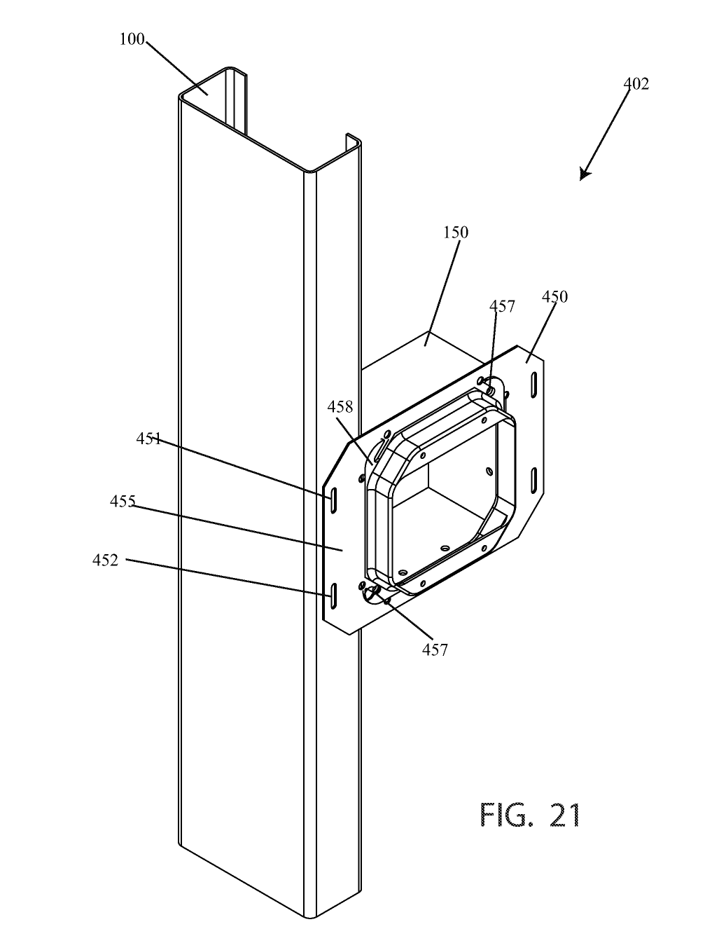

FIG. 21 shows how an electrical box 150 which is coupled to mounting bracket 450 can be coupled directly to a framing member 100. In this case, the mounting bracket 450 is rotated 90 degrees relative to the orientation of FIG. 20. Slots 451 and 452 are then used to connect mounting bracket to column 100 via connection elements or fasteners such as sheet metal screws inserting through slots 451 and 452 and screwing into column 100. When these fasteners such as sheet metal screws are fastened to column 100 the heads of these sheet metal screws clamp down on mounting plate 450 thereby securing it to column 100 and fixing it against any movement including any lateral or rotational movement. However, due to the elongated shape of slots 451, and 452, before these fasteners or sheet metal screws are screwed so that they are pressed against plate 450, mounting bracket 450 is adjustable in height as well.

In addition, as shown in this view, bracket section 455 extends along a side of bracket 450 providing support for bracket 450 against any movement inward when a user applies any force against bracket 450.

Components used in the design of these components can be in the form of 16 gauge galvanized steel, however different thicknesses and materials can be used. As stated the above fasteners or sheet-metal screws can be used as a means for fastening in this design however other methods of joining may also be used such as rivets, machine screws and nuts, spot welding or other known connection methods. In addition, manufacturing methods for producing these components can include but not be limited to sheet-metal bending, punching, and roll forming.

The speed of assembly and installation of electrical components is enhanced because now, multiple different configurations of electrical boxes are possible using standard pre-designed equipment. All of these materials can be pre-formed in a factory and then shipped to a job site, allowing users to assemble these components for use in installing wall or electrical boxes. Alternatively, a jobsite can stock the brackets and channels at the shop and then cut the channels to length as needed. In the case of the channels, the installed can keep a stock of channels in the raw length (i.e.—eight foot sections) without having to order multiple configurations.

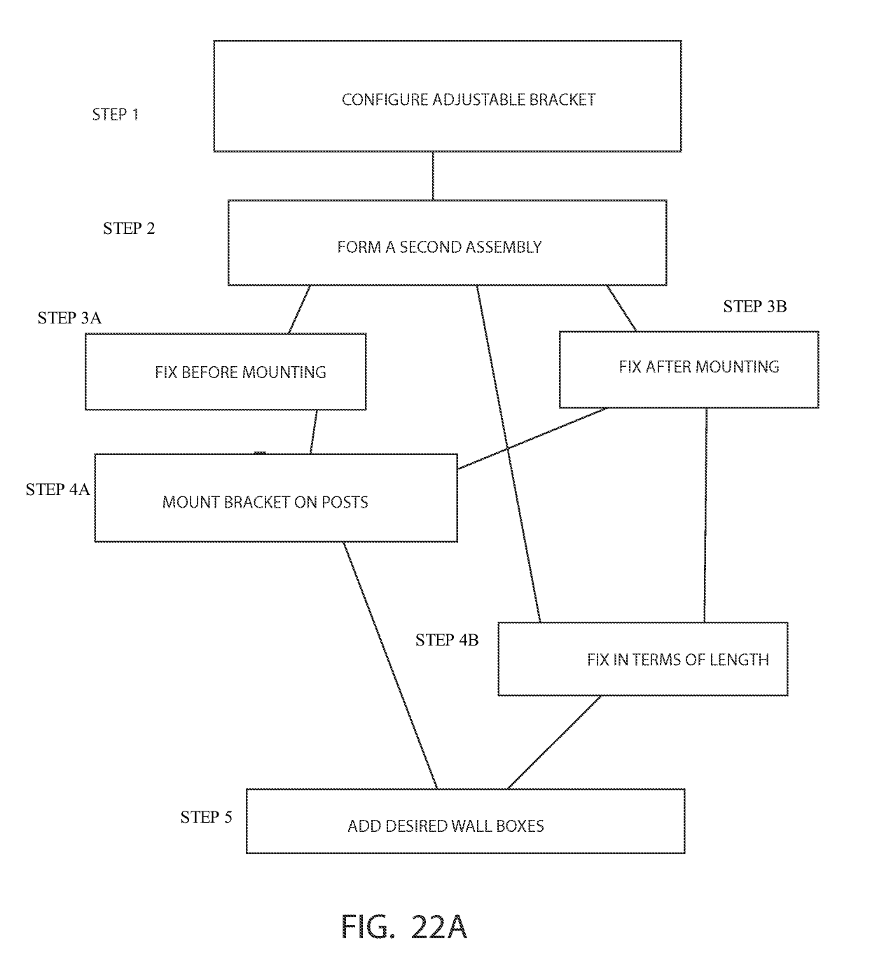

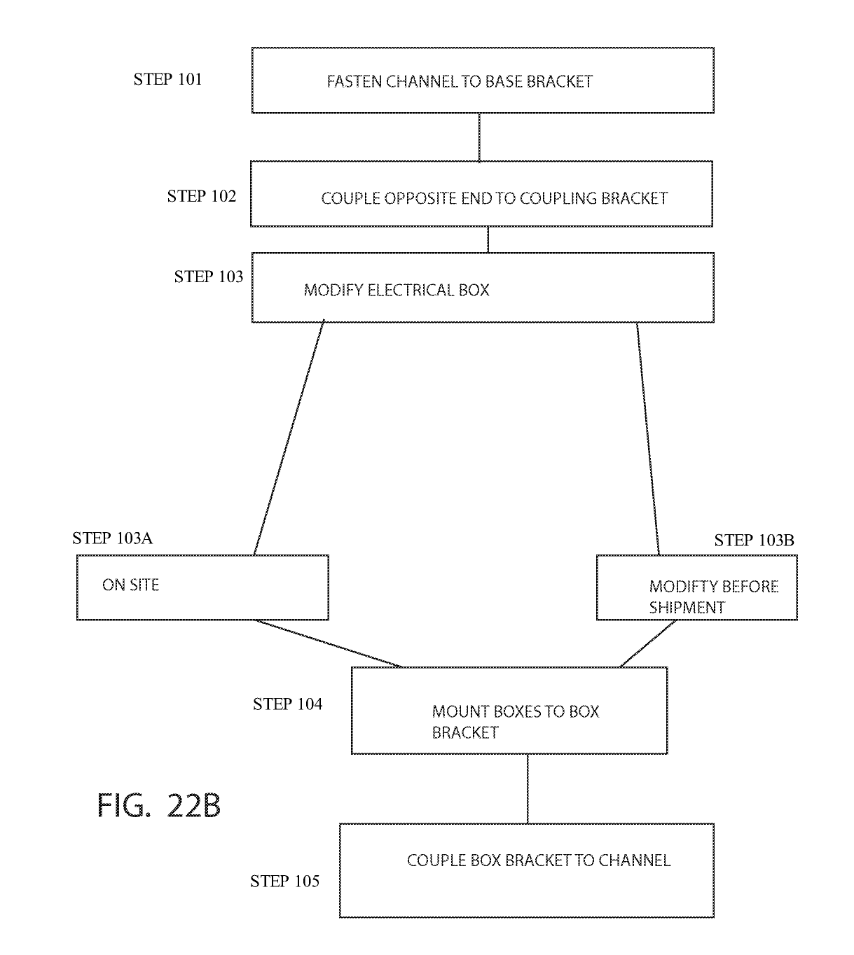

FIGS. 22A and 22B show examples of methods for using the above embodiments. For example FIG. 22A, shows one method for installation would include a first step of configuring an adjustable bracket by connecting an angle bracket to a first leg or track member or set of legs or track members to form a first assembly. The next step 2 includes forming a second assembly by coupling a second angle bracket to a second leg or track member or set of legs or set of track members. Next in step 3, the first assembly and the second assembly are assembled together in a slidable manner. At this point, the first assembly and the second assembly can be fixed before mounting, or alternatively, fixed after mounting. If the assembly forming the adjustable bracket is fixed before mounting in step 3a, then fasteners such as screws are inserted into the sets of legs to set the first assembly in relation to the second assembly.

Alternatively, in step 3b, a user can place the two end brackets against mounting framing members such as beams or posts to determine the desired expansion. Next in step 4, a user could either mount the adjustable bracket on the framing member (See step 4a), or fix the bracket in terms of length in step 4b, and then mount it on the framing members. Next, in step 5, the user can then add the desired wiring boxes to the adjustable bracket.

FIG. 22B shows an example of a method for a second embodiment, wherein only one set of legs or nested track members is formed via either a single leg or a set of legs. In this case, the user would then first in step 101 fasten the single leg such as channel 210 to a base bracket 220, and then in step 102 couple the opposite end to an opposite framing member via an end coupling bracket 500. In step 103, the electrical box bracket can then be modified either on site (step 103a) or before shipment (Step 103b). This modification can be for setting the length of spacer bracket 400 based upon the pre-defined bend lines based upon pre-defined depths of a wall. Next in step 104, electrical boxes can then be mounted to this box bracket 300. Next, in step 105, an electrical box bracket is then coupled to the framing member, track or bracket to set the desired position of the electrical boxes.

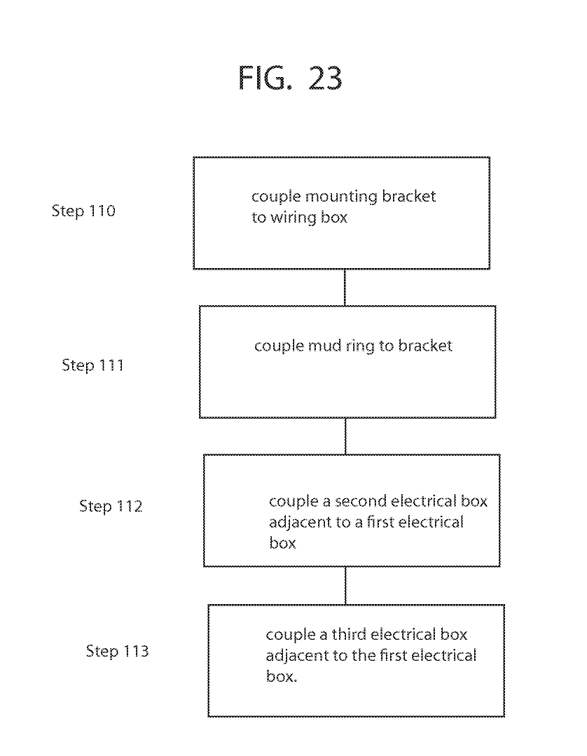

FIG. 23 shows the process for assembling electrical boxes using the components shown in FIG. 1A. For example, step 110 includes coupling at least one mounting bracket such as bracket 250a, to a wiring box such as wiring box 150. This coupling can occur by coupling at least one tab such as tab 278 or tab 288 to a wiring box 150 via a fastener. The fastener would extend through a fastening hole such as fastening hole 279 or 289 in the associated tab to couple this bracket 250a to box 150. In step 111, bracket 250a is coupled to a mud ring such as mud ring 350 via fasteners to form an assembled electrical box. The coupling of mud ring 350 to bracket 250a can occur by rotating connection hooks such as connection hooks 352 and 353 around a fastener coupled to fastening holes such as fastening holes 261a, 263a, 267a, 269a, 271, and 272. Next, once the electrical box is assembled, it can be positioned adjacent to another electrical box on a support such as adjustable bracket 11 or adjustable bracket 20. Thus, step 112, includes positioning a first electrical box including bracket 250a, adjacent to a second electrical box including another bracket 1250a such that flanges such as flanges 258a and 1256a interdigitate and allow the boxes to have openings with center regions positioned at a substantially same level. Step 113 includes coupling an additional box adjacent to the first electrical box opposite the first electrical box. In this case, the front contact surfaces of these brackets 250a, 1250a, and 2250a all extend along a substantially similar plane with center regions of these brackets being positioned substantially along the same axis such as a horizontal axis. Examples of step 112 are shown in FIGS. 2B and 2D while an example of step 113 is shown in FIG. 2C.

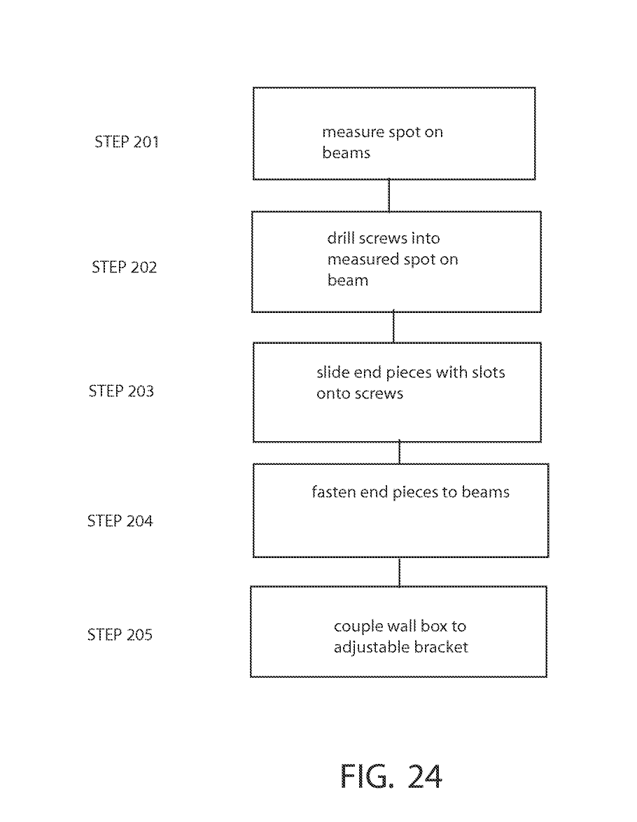

FIG. 24 is a flow chart for installing the embodiment shown in FIGS. 19-21. For example, in step 201, the desired spot on the vertical framing members 100 and 110 are measured so that a user can determine the position for installation on these framing members.

Next, once this position is determined, a user in step 202 can drill a fastener such as screws at least partially into these measured or determined positions in framing members 100 and 110. Once the fasteners are positioned in these framing members, the end pieces or end brackets 130 and 140 are coupled to these vertical framing members, wherein end bracket 130 is slid onto vertical framing member 100 wherein slot 136 slides around a partially drilled fastener or screw. In addition, bracket 140 is coupled to vertical framing member 110 via end bracket 140 which is slid onto vertical 110 such that slot 146 slides around a corresponding partially drilled fastener or screw. Once these slots are fitted around corresponding screws, step 203 has been completed.

Next, step 204 involves fastening these end pieces to the framing member. One way this step can be achieved, is by fastening down or screwing down the fasteners or screws around their corresponding slots to fix these end pieces in place. This step would be sufficient to fasten these end brackets to the corresponding framing member because leveling flanges 131 and 141 would be sufficient to keep end brackets 130 and 140 from rotating or moving once a fastener or screw secures this end bracket to corresponding framing member 100 and 110.

Another way to secure or fasten these end pieces 130 and 140 to their corresponding framing members would be to add additional fasteners or screws by drilling these fasteners or screws into holes 139 above, and/or below slot 136 on end bracket 130 or into holes 149 above and/or below slot 146 on end bracket 140. These additional fasteners such as screws insert through the corresponding holes 139 or 149 to further fasten end pieces 130 and 140 to framing members 100 and 110 respectively.

In most instances, the adjustable bracket 20 which includes elements 60 and 70 would already be coupled to end brackets 130 and 140. In that case, the only step needed to complete the installation would be step 205 wherein the wiring box 150 is coupled to adjustable bracket 20, once adjustable bracket 20 is coupled to vertical framing members 100 and 110 via steps 201-204.

Alternatively, wiring box 150 can already be coupled to adjustable bracket 20 before it is mounted to vertical framing members 100 and 110. In another alternative process, the end brackets 130 and 140 can be mounted first, and then adjustable bracket 20 is mounted to these end brackets 130 and 140 via fasteners such as screws inserting through respective holes 138 and 148 thereby securing adjustable bracket 20 to end brackets 130 and 140.

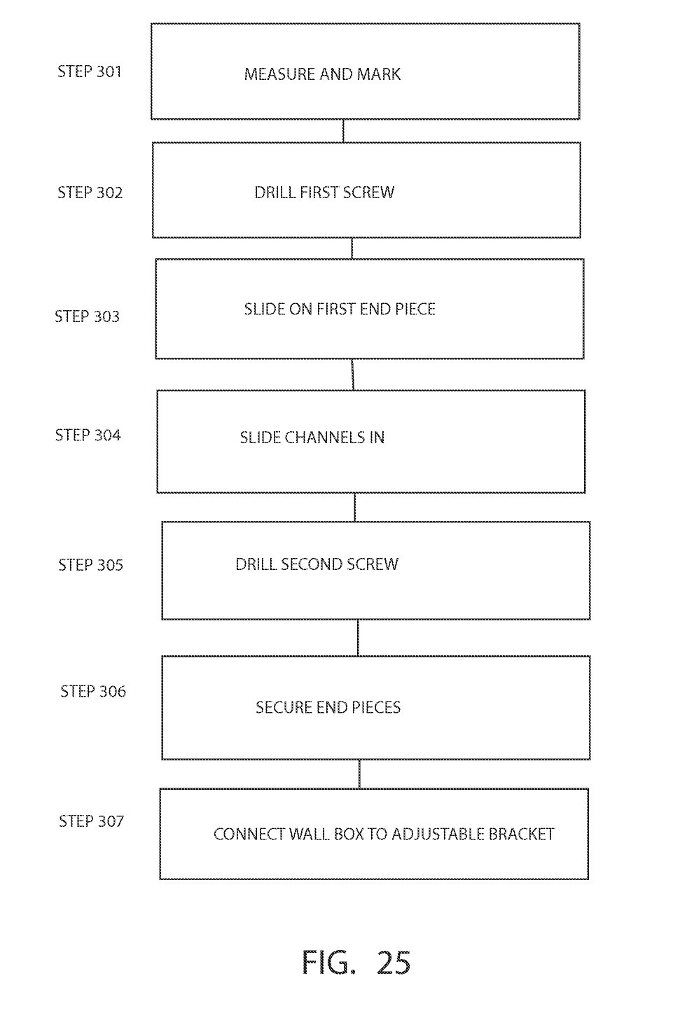

In another process, the adjustable bracket 20 is formed in two pieces, and then assembled on the job site. In this case, as shown in FIG. 25, the user proceeds through step 301, by measuring the proper spot or elevation on framing members 100 and 110. Next, in step 302, at least one fastener such as a screw is drilled into the measured spot on framing member 110. In step 303 an end piece with a slot is slid onto beam 110 with slot 136 being lined up on the associated screw. At this point, channels 60 extend out substantially perpendicular from framing member 110. Next, in step 304 channels 70 are slid into channels 60 such that end piece 140 is now positioned opposite end piece 130. Next, in step 305 an opposite fastener such as a screw is screwed into framing member 100 so that end piece 140 having slot 146 is slid onto the partially drilled fastener such as a screw. Next, in step 306 the end pieces are fastened to the framing members. In this case, the end piece 130 can be fastened to framing member 110 first, before fastening end piece 140 to framing member 100. Alternatively, the first fastener such as a screw can be drilled in to set end piece 130 first, with end piece 130 being fully secured to framing member 110 (such as after step 303 and before step 304) and then another screw can be screwed in to secure framing member 110 such as in step 306.

In step 307 the wiring box 150 is connected to the adjustable bracket 20 via bracket 450.

One of the benefits of these embodiments is that it is adapted to add further adjustability/reconfigurability and to aid in the speed of installation of wiring devices. This improved adaptability allows electrical boxes to be installed according to the user/installation's requirements, i.e., at various heights or locations as desired by the user or required by the installation (e.g., varying stud or framing member spacing's, varying heights according to regional building codes, in ceilings, in walls, in floors, etc.). In addition, different embodiments of the invention may be comprised of elements that can be reconfigured in size by simply varying the lengths of the constituent brackets. Furthermore, the systems may use as some of the components standard, off-the-shelf commercially available parts. In this sense, the user can keep a stock of standard length brackets, eight foot lengths for example, and the various other parts of the system. When needed, the brackets can simply be cut to the length and assembled into whichever configuration is required/desired for a particular installation.

Another feature of one embodiment of this invention is the capability to use commercially available electrical wiring boxes, mud rings, and other components in conjunction with the system.

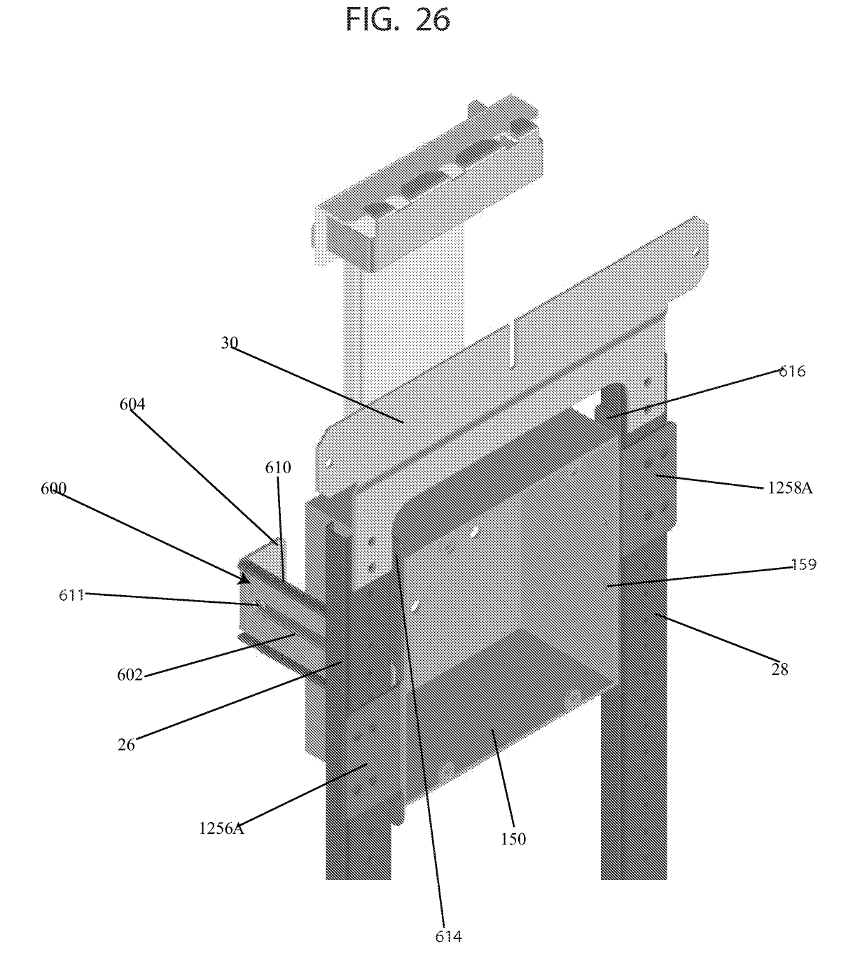

In another embodiment that shown in FIGS. 26, 27, and 28, there is shown adjustable far side supports 600 and 601, which are adjustable in length to provide depth adjustment. These adjustable far side supports 600 and 601 are adjustable along tracks 610 and 612, formed integral with respective flanges 1256a and 1258a thereby forming brackets 614 and 616 respectively. Flange 1256a has drill holes 1257a, while flange 1258a has drill holes 1259a, wherein each of these drill holes are configured to receive a fastener. Tracks 610 and 612 can have any acceptable shape, however track 610 is shown in this embodiment as having a C-shaped cross section to allow a bracket 604 or 605 to slide therein. Adjustable far side supports 600 and 601 have respective slots 602 and 603 formed in brackets 604 and 605 respectively, which allow for depth adjustment with respect to tracks 610 and 612. Tracks 610 and 612 can have optional respective screw holes 611 and 613, or slots themselves to allow for fixation of brackets 604 and 605 after depth adjustment. Fixation can be via the use of a fastener as described above, which is fitted through slots 602 and 603 and holes 611 and 613. In one embodiment the fastener is a screw, and holes 611 and 613 are threaded. Brackets 604 and 605 are formed as angle brackets which can be L-shaped. These respective angle brackets 604 and 605 are for direct contact to a backside wall to provide support against this wall. In this case, the adjustable far side supports can be used with either brackets or columns that are not adjustable in length or brackets or columns that are adjustable in length. Brackets 604 and 605 are substantially L-shaped with respective flattened sections 604b and 605b forming support sections for contacting with a back wall.

With this design, a user can then adjust the depth wherein the depth adjustment is based upon the distance that a wall box such as wall box 150 is spaced apart from a far side wall. Wall box 150 is coupled to brackets 614 and 616 via screw holes 159 formed in wall box 150, and fasteners coupled through these holes such as a rivet.

Once the depth is adjusted on these far side supports 600 and 601, the user can fix this positioning via any known fixing elements such as via any known fasteners. Known fasteners include: screws, rivets, bolts and nuts; welding; clipping, crimping or any other known devices or methods.

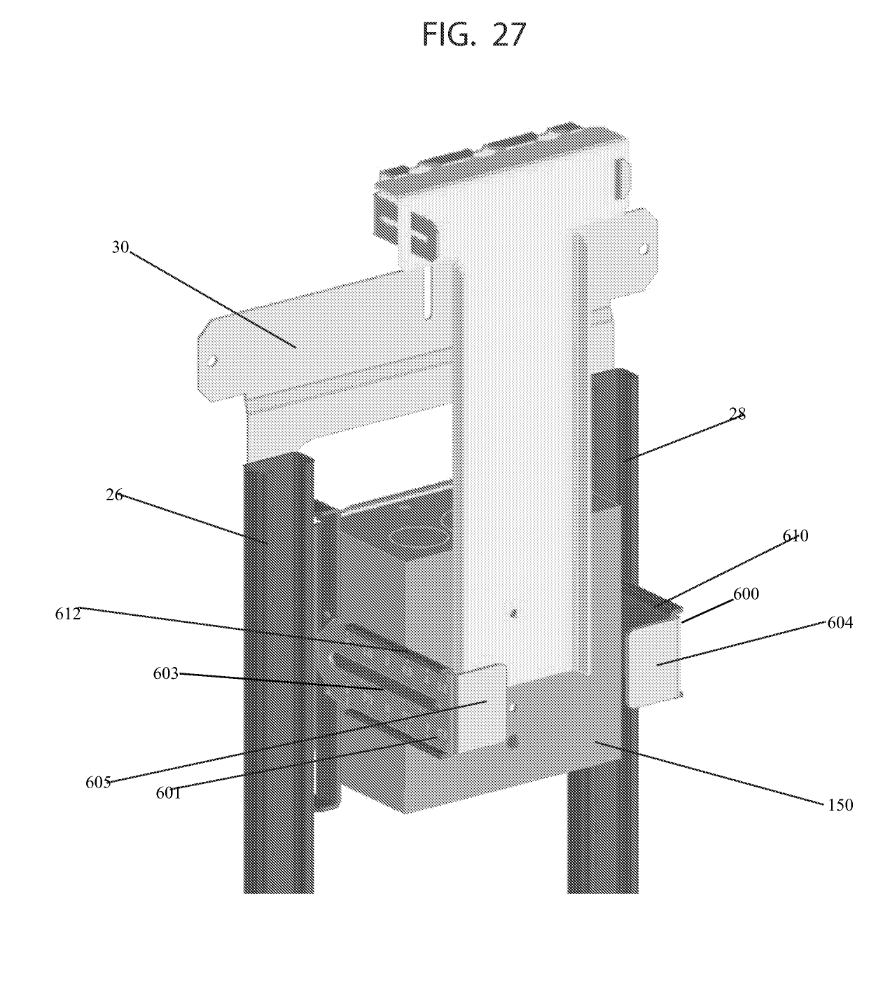

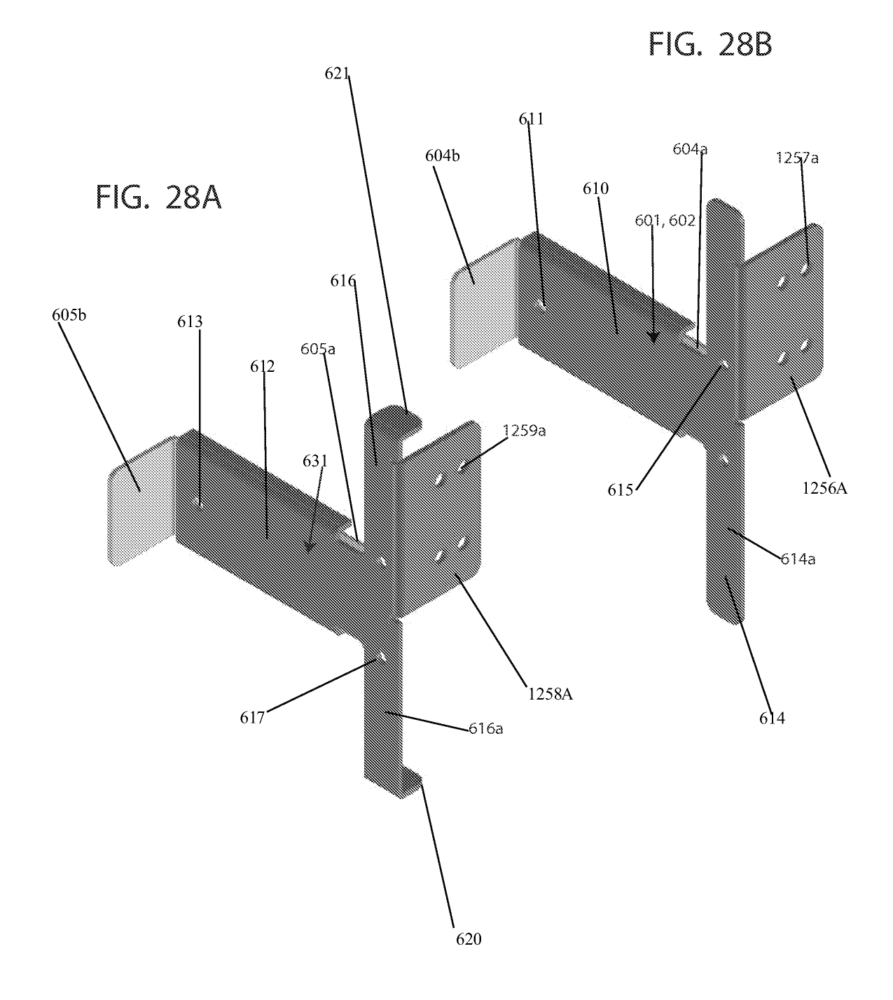

FIGS. 28A and 28B show the two types of brackets that can be used for the embodiments of FIGS. 26 and 27. The difference between FIGS. 28A and 28B is that FIG. 28A includes angled tabs 620 and 621 which fit alongside a wall box such as wall box 150. The brackets shown in FIGS. 28A and 28B form the brackets 614 and 616 shown in FIGS. 26 and 27. Bracket 614 is formed substantially T-shaped, and includes a body section 614a, drill holes 615 and C-shaped arm 610. C shaped arm 610 includes a drill hole 611 which is used to accept a fastener, which is used to lock movement of angle bracket 604. Bracket 616 is formed substantially T-shaped, and includes a body section 616a, drill holes 617 formed in body section 616a, and C-shaped arm 612 extending off of body section 616a. C shaped arm 612 includes a drill hole 613 which is used to accept a fastener to lock movement of angle bracket 605. C-shaped arm 612 is configured to accept far side brackets such as brackets 604 and 605 which are slidable in this arm.

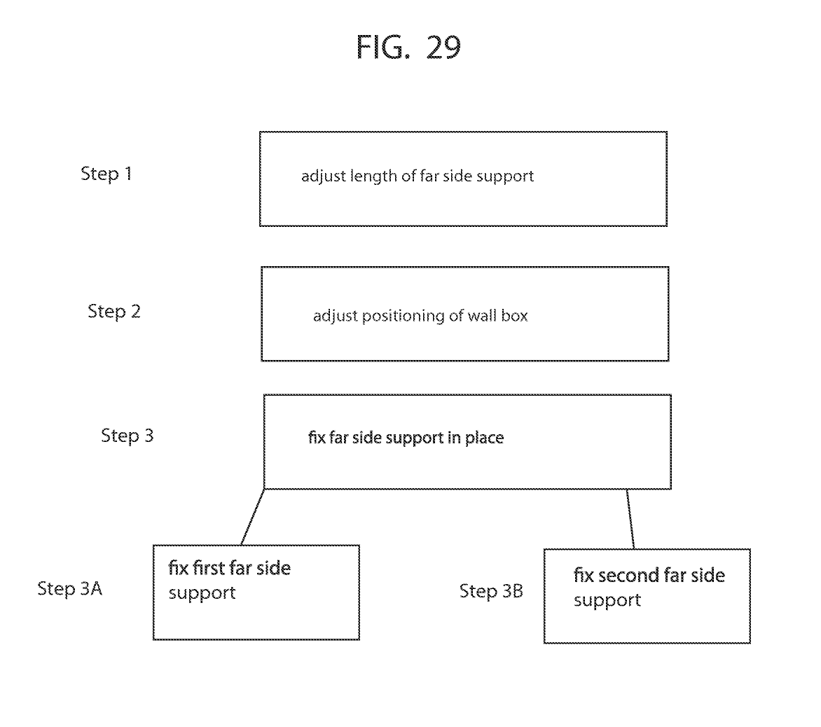

FIG. 29 is a flow chart disclosing the process for configuring the depth adjustment of these far side brackets. For example, once a user fixes his wall box 150 to legs 26 and 28, the user can in step 1, adjust the length of the far side support 600 and 601 against a back wall. In step, 2 the user can then also further adjust the positioning of the wall box 150 relative to the wall surface adjacent to the wall box, by adjusting the positioning of the front side of the wall box relative to adjacent studs or columns. Steps 1 and 2 can be performed in any order wherein step 2 can be performed before step 1. Next, the depth positioning of the wall box is fixed in step 3 such that in step 3A the first far side support 600 is fixed in place, and then in step 3B the second far side support 601 is fixed in place. These steps allow for the depth adjustment of the wall box 150 relative to a far side support, and thus relative to a wall surface as well. This system can be used with another system which allows for height adjustability such as that shown in the embodiment of FIG. 4A or with a design of preset length such as that shown in FIG. 14.

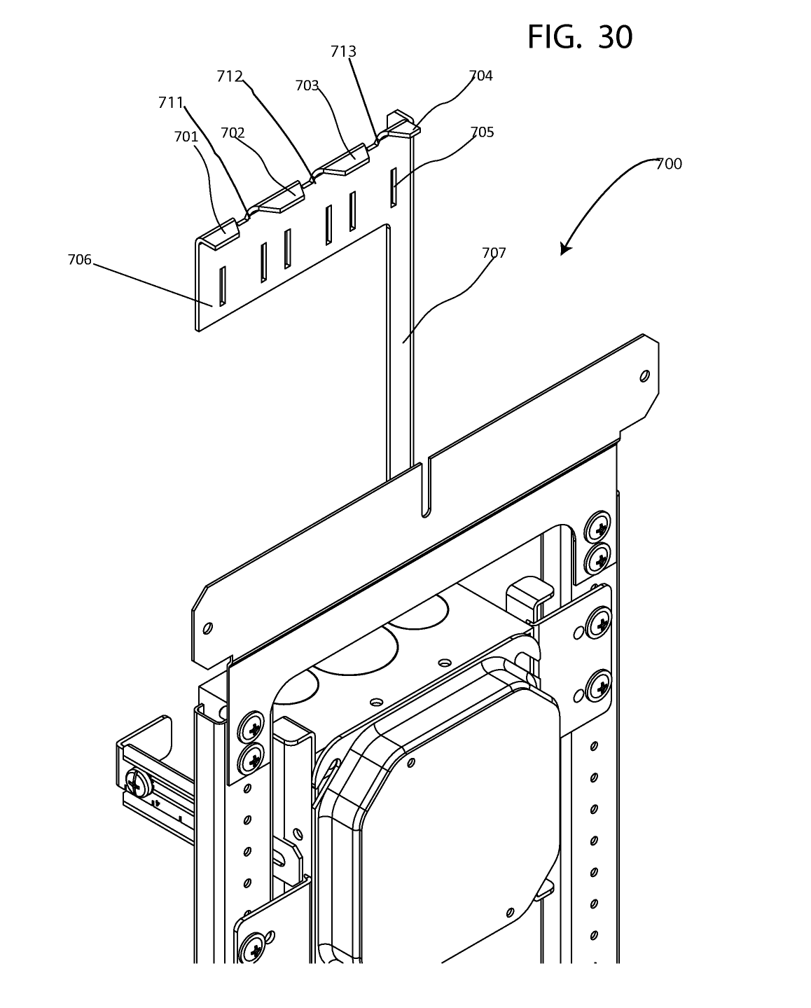

FIG. 30 is a front perspective view of a cable guide 700 which is coupled to a wall box. Cable guide 700 includes fingers 701, 702, 703, and 704, which are coupled to a bracket section 706 having recesses 705. These recesses 705 are used to receive cable ties which are used to couple the cables to the cable guide 700. Disposed between these fingers are recesses 711, 712, and 713 which are configured or adapted to receive cables such as power cables.

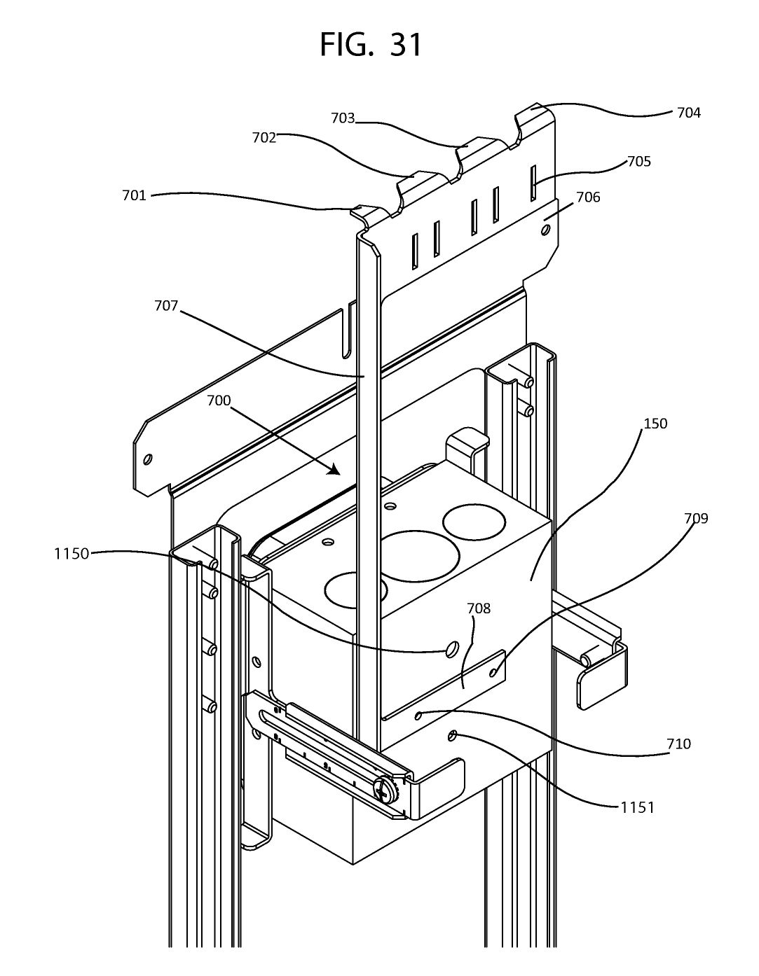

FIG. 31 shows a back view of this cable guide 700, which includes a L-shaped bracket including an extension arm 707, and a coupling arm 708. Coupling arm 708 includes drill holes or fasteners 709 and 710 which are configured or adapted to couple to the back end of the wall box 150. Wall box 150 includes drill holes 1150 and 1151 which are designed to receive a fastener such as a nut, bolt, screw, rivet, or any other known fastener described above. In this view, extension arm 707, extends in a direction parallel to the extension direction of tracks 22 or 24.

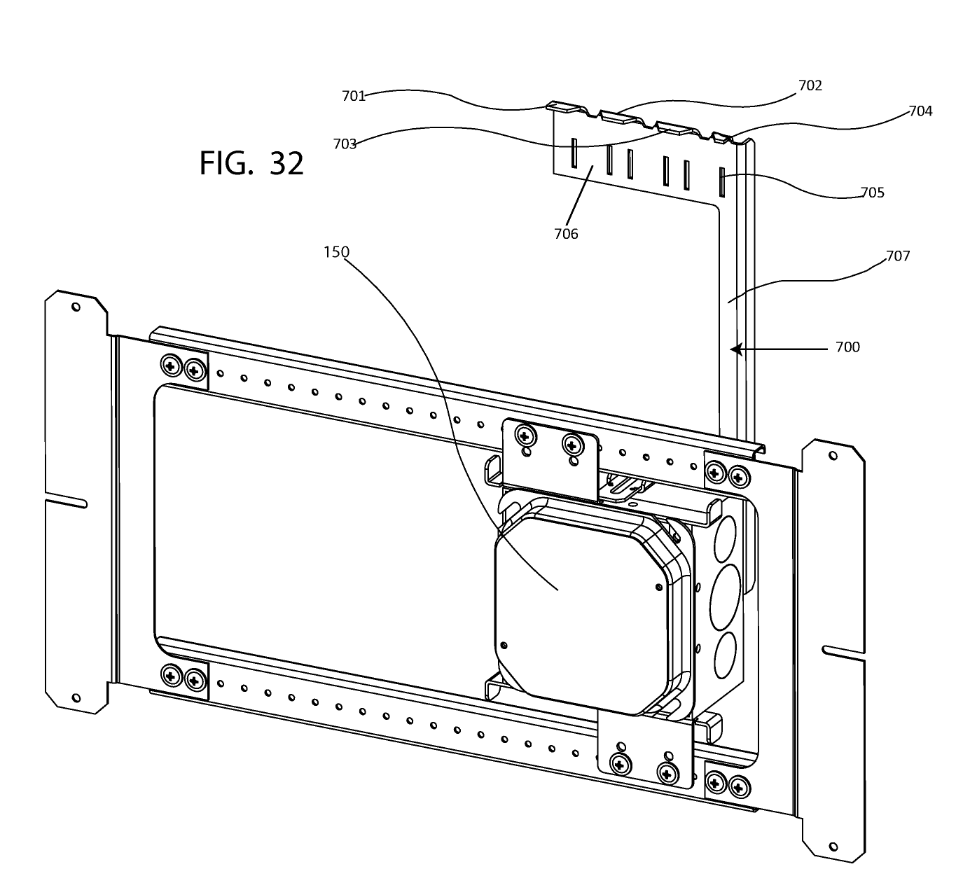

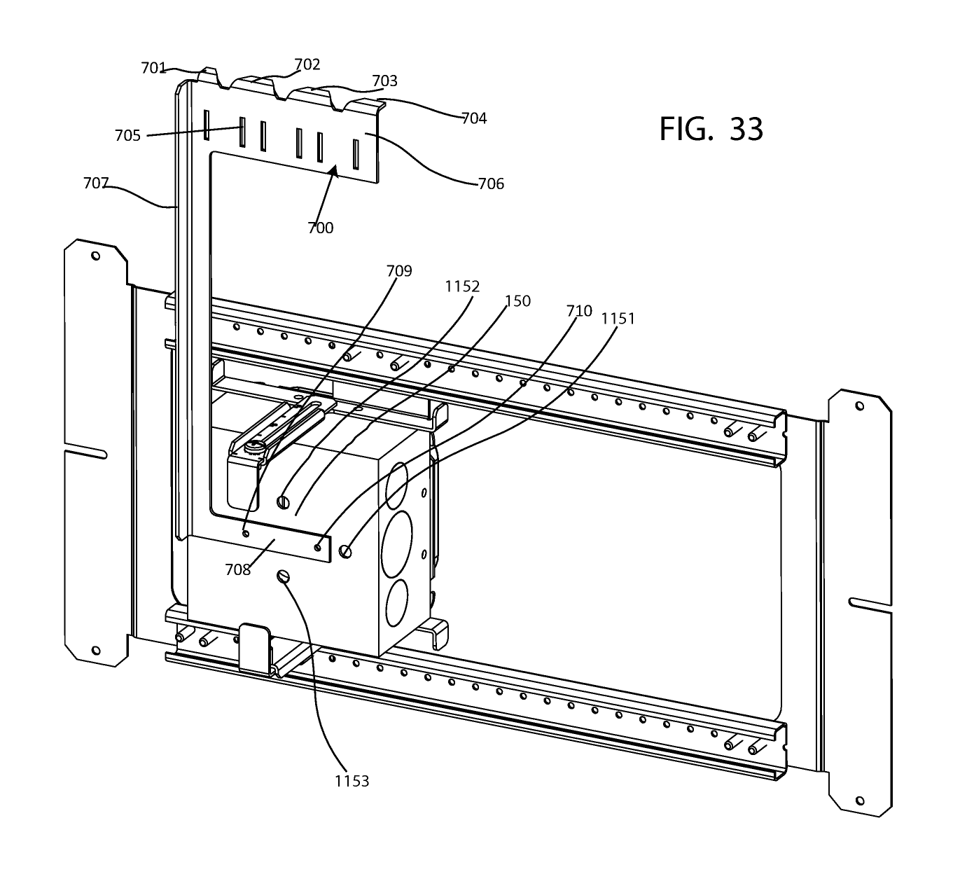

This cable guide 700 is configured such that it can be coupled in at least two different orientations. For example, the first orientation is shown in FIGS. 30 and 31. The second orientation is shown in FIGS. 32 and 33. In this orientation, as shown in FIG. 32 which shows the front view, the length of the extension arm extends transverse to the extension of tracks 22 or 24. FIG. 33 shows the back view for the configuration for this orientation wherein coupling bracket 708 having fastening holes 709 and 710 are shown coupled to wall box 150 in a manner that is rotated such as rotated approximately 90 degrees with respect to the orientation shown in FIG. 31. The adjustability of this cable guide with respect to orientation allows for the wall box to be mounted in at least two different orientations as well. In addition, in this back view, wall box holes 1151, 1152 and 1153 are shown, wherein these different wallbox holes allow for coupling bracket 708 at different angles via a fastener.

Accordingly, while only a few embodiments of the present invention have been shown and described, it is obvious that many changes and modifications may be made thereunto without departing from the spirit and scope of the invention.

What is claimed is:

1. A bracket for coupling to a wiring box comprising:
a) at least one body section comprising a plurality of body fastener holes and at least four sides; and
b) a first flange having a flange fastener hole, said first flange extending from at least a portion of a first side of said at least four sides; and
c) at least one far side support bracket which is adjustable in depth to provide adjustable far side support against an opposite wall for the bracket;
wherein said first flange is configured and arranged on said first side to interdigitate with a complementary flange from another bracket when said other bracket is mounted adjacent to said first side.

2. The bracket as in claim 1, wherein said complementary flange is a flange coupled to an adjacent bracket, wherein said adjacent bracket is coupled to a wiring box which is different from the wiring box coupled to said first flange.

3. The bracket as in claim 1 wherein said farside support bracket comprises at least one arm that is adjustable in length.

4. The bracket as in claim 2, wherein said at least one arm comprises at least two arms wherein at least a first arm is slidable along at least a second arm to provide depth adjustability for said farside support bracket.

5. The bracket as in claim 4, wherein said at a second arm is coupled to a body section of said farside support bracket.

6. The bracket as in claim 5, wherein said second arm has at least one section that has a C-shaped cross section, and wherein said first arm is slidable inside said C-shaped cross section.

7. The bracket as in claim 6, wherein said second arm has at least one securing element for fixing a movement of said first arm in said second arm.

8. The bracket as in claim 7, wherein said first arm has a securing element for securing said first arm to said securing element of said second arm.

9. The bracket as in claim 7, wherein said second arm securing element comprises at least one hole, wherein said hole is for receiving a screw.

10. The bracket as in claim 8, wherein said first arm securing element comprises an elongated track.

11. The bracket as in claim 10, wherein said first arm comprises a plurality of indicators to indicate a depth position of said first track relative to the bracket.

12. The bracket as in claim 4, wherein said first arm is L-shaped.

13. A reconfigurable electrical component mounting system comprising:
a) a mounting bracket comprising:
i) at least one body section comprising a plurality of body fastener holes and least four sides;
ii) at least one flange extending out from at least a portion of a first side of said at least four sides, said at least one flange having fastener holes;
wherein said at least one flange is arranged and configured on said first side so as to form a gap for receiving a complementary flange from another bracket adjacent to said at least one flange; and
b) a wiring box coupled to said mounting bracket; and
c) at least one far side support bracket which is adjustable in depth to provide adjustable far side support against an opposite wall for the bracket.

14. The system as in claim 13, further comprising a mud ring coupled to at least one of said mounting bracket and said wiring box.

15. The system as in claim 13, further comprising:
at least one adjustable bracket which is adjustable in length, said at least one adjustable bracket comprising at least one track;
at least one fastener for fastening said at least one mounting bracket to said at least one adjustable bracket; and
at least one end plate coupled to said at least one adjustable bracket.

16. The system as in claim 13, wherein said at least one end plate has an elongated slot disposed substantially in a center region of said end plate.

17. The system as in claim 15, wherein said at least one track comprises at least two nested track members wherein at least one of said at least two nested track members has a plurality of holes spaced apart from each other and wherein another nested track member taken from said at least two nested track members has at least one hole.

18. The system as in claim 15, further comprising at least one cable guide, said cable guide having an extension arm, a plurality of fingers and a coupling arm, said coupling arm being adapted to allow said cable guide to be mounted to said wiring box in at least two different orientations.

19. A method for installing a wall box comprising the following steps:
a) adjusting a length of a far side support bracket;
b) adjusting a position of a wall box; and
c) fixing a position of a far side support bracket such that said far side support bracket is fixed in length.

20. The process as in claim 19, wherein said step of adjusting a length of a farside support bracket comprises fixing a first far side support in place, and then fixing a second farside support in place.

21. The process as in claim 19, wherein said step of adjusting a length of a farside support bracket comprises sliding a first arm inside of a second arm and then fixing said first arm to said second arm.

22. The process as in claim 21, wherein said step of adjusting a length of a farside support bracket comprises analyzing a depth of adjustment of a first farside support bracket based upon indicia and then fixing a depth of said first farside support bracket, and then analyzing a depth of adjustment of a second farside support bracket based upon indicia and then fixing said second farside support bracket in place.
